(19) United States
(12) Patent Application Publication
(10) Pub. No.: US 2008/0291408 A1
(43) Pub. Date: Nov. 27, 2008

(54) Projection optical system, exposing method, exposure apparatus, and device fabricating method

(75) Inventor: Hiroyuki Nagasaka, Kumagaya-shi (JP)

Correspondence Address: OLIFF & BERRIDGE, PLC, P.O. BOX 320850, ALEXANDRIA, VA, 22320-4850, US

(73) Assignee: NIKON CORPORATION, Tokyo (JP)

(21) Appl. No.: 12/153,341

(22) Filed: May 16, 2008

Related U.S. Application Data
(63) Continuation of application No. PCT/JP2007/059982, filed on May 15, 2007.
(60) Provisional application No. 60/924,545, filed on May 18, 2007.

(30) Foreign Application Priority Data
May 16, 2006 (JP) 2006-136387

(51) Int. Cl. G03B 27/54; G03B 27/52

(52) U.S. Cl. 355/30; 355/67

(57) ABSTRACT

A projection optical system projects an image of a first surface to a second surface through a liquid. The projection optical system comprises an optical element, wherein the first surface side contacts a gas and the second surface side contacts the liquid. The optical element has an incident surface, which is convex toward the first surface, an emergent surface, an outer circumferential surface between an outer circumference of the incident surface and an outer circumference of the emergent surface, and holding parts, which are formed at a circumferential edge part of the outer circumferential surface so that they project toward the second surface.

### CROSS-REFERENCE TO RELATED APPLICATION

This application is a non-provisional application claiming priority to and the benefit of U.S. provisional application No. 60/924,545, filed May 18, 2007, and is a Continuation Application of International Application No. PCT/JP2007/059982, filed May 15, 2007, which claims priority to Japanese Patent Application No. 2006-136387, filed May 16, 2006.

### BACKGROUND

1. Field of the Invention

The present invention relates to a projection optical system, an exposing method, an exposure apparatus, and a device fabricating method.

2. Description of Related Art

In photolithography, which is one of the processes in the fabrication of microdevices such as semiconductor devices, an exposure apparatus is used that projects an image of a pattern formed on a mask onto a photosensitive substrate through a projection optical system. In the field of microdevice fabrication, there is demand to increase the fineness of the patterns formed on substrates in order to increase device density. To meet this demand, it is preferable to further increase the resolution of exposure apparatuses. As one means of increasing resolution, an immersion exposure apparatus has been proposed that fills an optical path space of exposure light between the substrate and an optical element of the projection optical system with liquid, and exposes the substrate through that liquid. Japanese Patent Application Publication No. 2001-74991A discloses one example of a technology related to a holding member that holds an optical element of a projection optical system. PCT International Publication WO99/049504 discloses one example of a technology related to an immersion exposure apparatus.

In a liquid immersion exposure apparatus, the higher the refractive index of the liquid that fills the optical path space of the exposure light, the more that the resolution and the depth of focus can be improved. Incidentally, if a liquid is used that has a high refractive index with the aim of obtaining a projection optical system with a large numerical aperture, then there is a possibility that, for example, the number of degrees of freedom in arranging the members that are disposed near the optical element that is closest to the image plane will decrease, and that the sizes of those members will increase. If the sizes of the members that are disposed in the vicinity of the optical element increase, then there is a possibility that the overall size of the exposure apparatus will increase.

In addition, there is a possibility that the physical properties of the liquid will change because of the environment that surrounds the liquid that fills the optical path space of the exposure light, e.g., because of the type of gas that contacts the liquid. If the physical properties of the liquid change, then there is a possibility that the radiation state of the exposure light with respect to the substrate will change, and that the projection state of the image of the pattern will deteriorate.

A purpose of some aspects of the present invention is to provide a projection optical system that can prevent the sizes of the members that are disposed near the optical element from increasing, as well as an exposing method and an exposure apparatus that use that projection optical system. Another purpose is to provide an exposure apparatus that can satisfactorily radiate expose light to a substrate through a liquid, as well as a device fabricating method that uses the exposure apparatus.

### SUMMARY

A first aspect of the invention provides a projection optical system that projects an image of a first surface to a second surface through a liquid and comprises: an optical element, which comprises: an incident surface, which is convex toward the first surface; an emergent surface; an outer circumferential surface between an outer circumference of the incident surface and an outer circumference of the emergent surface; and holding parts, which are formed at a circumferential edge part of the outer circumferential surface so that the holding parts project toward the second surface; wherein, the incident surface contacts a gas; and the emergent surface contacts the liquid.

According to the first aspect of the invention, it is possible to prevent an increase in the size of the members that are disposed close to the optical element of the projection optical system.

A second aspect of the invention provides an exposing method that comprises: filling a space between a substrate and a projection optical system according to the abovementioned aspect with a liquid; and exposing the substrate through the projection optical system and the liquid.

According to the second aspect of the invention, it is possible to radiate exposure light to the substrate satisfactorily through the projection optical system and the liquid discussed above.

A third aspect of the invention provides an exposure apparatus that exposes a substrate by radiating exposure light to the substrate through a projection optical system and a liquid, and comprises: a projection optical system according to the abovementioned aspects.

According to the third aspect of the invention, it is possible to radiate exposure light to the substrate through the liquid satisfactorily while preventing an increase in size as a result of mounting the projection optical system discussed above.

A fourth aspect of the invention provides an exposure apparatus that exposes a substrate by radiating exposure light to the substrate through a liquid, and comprises: an optical element, which comprises: an incident surface into which the exposure light enters; an emergent surface from which the exposure light emerges; an outer circumferential surface between an outer circumference of the incident surface and an outer circumference of the emergent surface; and holding parts, which are formed at a circumferential edge part of the outer circumferential surface so that the holding parts project toward the substrate; and an immersion space forming member, which forms an immersion space between the optical element and a front surface of the substrate; wherein, a space is formed between the holding parts and the outer circumferential surface at least along a direction that is perpendicular to the optical axis of the optical element; and at least part of the immersion space forming member is disposed in the space.

According to the fourth aspect of the invention, it is possible to radiate exposure light to the substrate through the liquid satisfactorily while preventing an increase in size.

A fifth aspect of the invention provides an exposure apparatus that exposes a substrate by radiating exposure light to the substrate through a liquid, and comprises: an optical element that has an incident surface into which the exposure light enters, and an emergent surface from which the exposure light emerges; an immersion space forming member, which forms an immersion space between the emergent surface of the optical element and a front surface of the substrate; a first gas supply port, which supplies a gas to a prescribed space on the incident surface side of the optical element; and a gas passageway, which is in fluid communication with the prescribed space and at least part of the gas space, which surrounds the immersion space, so that the gas that is supplied via the first gas supply port contacts the liquid of the immersion space.

According to the fifth aspect of the invention, it is possible to radiate exposure light to the substrate through the liquid satisfactorily.

A sixth aspect of the invention provides an exposure apparatus that exposes a substrate by radiating exposure light to the substrate through a liquid, and comprises: an optical element, which comprises: an incident surface into which the exposure light enters; an emergent surface from which the exposure light emerges; an outer circumferential surface between an outer circumference of the incident surface and an outer circumference of the emergent surface; and holding parts, which are formed at a circumferential edge part of the outer circumferential surface so that the holding parts project toward the substrate; and an immersion space forming member, which forms an immersion space between the optical element and a front surface of the substrate; wherein, a space is formed between the optical axis of the optical element and the holding parts; and at least part of the immersion space forming member is disposed in the space.

According to the sixth aspect of the invention, it is possible to radiate exposure light to the substrate through the liquid satisfactorily while preventing an increase in size.

A seventh aspect of the invention provides a device fabricating method that uses an exposure apparatus according to the abovementioned aspects.

According to the seventh aspect of the invention, it is possible to fabricate a device using the exposure apparatus that can radiate exposure light to the substrate through the liquid satisfactorily.

According to some aspects of the present invention, it is possible to expose a substrate through a liquid satisfactorily, and thereby to fabricate a device that has a desired performance specification.

### BRIEF DESCRIPTION OF THE DRAWINGS

FIG. 1 is a schematic block diagram that shows an exposure apparatus according to a first embodiment.

FIG. 2A is an oblique view that shows an optical element according to the first embodiment, viewed from the incident surface side.

FIG. 2B is an oblique view that shows the optical element according to the first embodiment, viewed from the emergent surface side.

FIG. 3 is an oblique view that shows part of the exposure apparatus according to the first embodiment.

FIG. 4 is a side cross sectional view that shows part of the exposure apparatus according to the first embodiment.

FIG. 5 is a plan view of FIG. 3, viewed from the −Z side.

FIG. 6 is a side cross sectional view that shows part of the exposure apparatus according to the first embodiment.

FIG. 7 is a schematic drawing for explaining the operation of the exposure apparatus according to the first embodiment.

FIG. 8 is a schematic drawing for explaining the operation of the exposure apparatus according to a second embodiment.

FIG. 9 is an oblique view that shows part of the exposure apparatus according to a third embodiment.

FIG. 10 is an oblique view of FIG. 9, viewed from the −Z side.

FIG. 11 is a side cross sectional view that shows part of the exposure apparatus according to the third embodiment.

FIG. 12 is a schematic drawing for explaining the operation of the exposure apparatus according to the third embodiment.

FIG. 13 is a schematic drawing for explaining the operation of the exposure apparatus according to a fourth embodiment.

FIG. 14 is a flow chart diagram that depicts one example of a process of fabricating a microdevice.

### DESCRIPTION OF EMBODIMENTS

The following explains the embodiments of the present invention referencing the drawings, but the present invention is not limited thereto. Furthermore, the following explanation defines an XYZ orthogonal coordinate system, and the positional relationships among members are explained referencing this system. Furthermore, prescribed directions within the horizontal plane are the X axial directions, directions that are orthogonal to the X axial directions in the horizontal plane are the Y axial directions, and directions that are orthogonal to the X axial directions and the Y axial directions (i.e., the vertical directions) are the Z axial directions. In addition, the rotational (the inclined) directions around the X, Y, and Z axes are the θX, θY, and θZ directions, respectively.

### First Embodiment

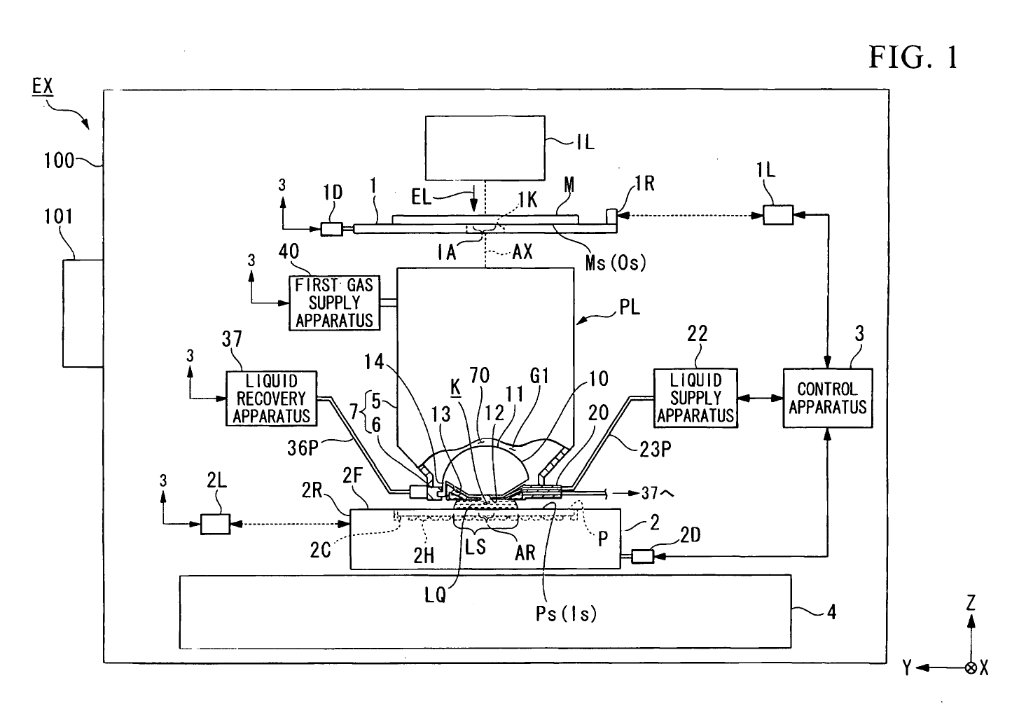

A first embodiment will now be explained. FIG. 1 is a schematic block diagram that shows an exposure apparatus EX according to the first embodiment. In FIG. 1, the exposure apparatus EX comprises a movable mask stage 1 that holds a mask M, a movable substrate stage 2 that holds a substrate P, an illumination system IL that illuminates a pattern of the mask M with exposure light EL, a projection optical system PL that projects an image of the pattern of the mask M, which is illuminated by the exposure light EL, onto the substrate P, and a control apparatus 3 that controls the operation of the entire exposure apparatus EX. Furthermore, the substrate P described herein includes one wherein films, for example, a protective film and a film of a photosensitive material (photoresist) are coated on a base material, such as a semiconductor wafer. The mask M includes a reticle wherein a device pattern is formed that is reduction projected onto the substrate P. The projection optical system PL projects an image of an object, which is disposed in an object plane Os, to an image plane Is through a liquid. The mask M has a patterned surface Ms, wherein a pattern is formed. In the explanation below, the patterned surface Ms is disposed so that it substantially coincides with the object plane Os, and a front surface Ps (exposure surface) of the substrate P is disposed so that it substantially coincides with the image plane Is. Furthermore, a transmitting type mask is used as the mask M in the present embodiment, but a reflection type mask may also be used.

In addition, the exposure apparatus EX comprises a chamber apparatus 100, which houses at least the illumination system IL, the mask stage 1, the projection optical system PL, and the substrate stage 2. An air conditioning unit 101 adjusts the environment (including the temperature and the humidity) of the interior of the chamber apparatus 100 to a desired state. In the present embodiment, the air conditioning unit 101 fills the interior of the chamber apparatus 100 with clean air.

In the present embodiment, the exposure apparatus EX is an immersion exposure apparatus that employs a liquid immersion method in order to shorten the exposure wavelength substantially, improve the resolution, and increase the depth of focus substantially, and comprises a nozzle member 20 that is disposed so that it opposes the front surface Ps of the substrate P and is capable of forming an immersion space LS between itself and the front surface Ps of the substrate P. The immersion space LS is a space that is filled with the liquid LQ. The nozzle member 20 can hold the liquid LQ between itself and the front surface Ps of the substrate P, and can thereby form the immersion space LS of the liquid LQ between itself and the front surface Ps of the substrate P.

The nozzle member 20 forms the immersion space LS so that an optical path space K of the exposure light EL between the projection optical system PL and the substrate P—specifically, between an optical element 10, which is the optical element of a plurality of optical elements of the projection optical system PL that is closest to the image plane of the projection optical system PL, and the front surface Ps of the substrate P, which is disposed at a position at which it opposes the optical element 10 on the image plane side of the projection optical system PL—is filled with the liquid LQ.

The optical path space K of the exposure light EL is a space that includes the optical path through which the exposure light EL travels. In the present embodiment, the optical path space K of the exposure light EL between the optical element 10 of the projection optical system PL and the front surface Ps of the substrate P is filled with the liquid LQ by using the nozzle member 20 to form the immersion space LS between the front surface Ps of the substrate P on one side and the nozzle member 20 and the optical element 10 that oppose such on the other side.

The exposure apparatus EX uses the nozzle member 20 to form the immersion space LS at least while the image of the pattern of the mask M is projected to the substrate P. The exposure apparatus EX radiates the exposure light EL, which emerges from the patterned surface Ms of the mask M, to the front surface Ps of the substrate P, which is held by the substrate stage 2, through the projection optical system PL and the liquid LQ of the immersion space LS. Thereby, the image of the patterned surface Ms of the mask M is projected onto the front surface Ps of the substrate P, which is thereby exposed.

In addition, with the exposure apparatus EX of the present embodiment, an immersion region is formed during the exposure of the substrate P on part of the substrate P that includes a projection region AR of the projection optical system PL. Namely, a local liquid immersion system is adopted wherein part of the region on the substrate P that includes the projection region AR of the projection optical system PL is covered with the liquid LQ of the immersion space LS.

Furthermore, the present embodiment principally explained the case wherein the immersion space LS is formed between the optical element 10 and the front surface Ps of the substrate P, but at least part of the immersion space LS can also be formed on the image plane side of the projection optical system PL between the optical element 10 and the front surface of an object that is disposed at a position at which it opposes the optical element 10. For example, at least part of the immersion space LS can also be formed between the optical element 10 and an upper surface 2F of the substrate stage 2 that is disposed at a position at which it opposes the optical element 10.

The exposure apparatus EX in the present embodiment is a scanning type exposure apparatus (a so-called scanning stepper) that projects the image of the pattern of the mask M onto the substrate P while synchronously moving the mask M and the substrate P in prescribed scanning directions. In the present embodiment, the scanning directions (the synchronous movement directions) of the substrate P are the Y axial directions and the scanning directions (the synchronous movement directions) of the mask M are also the Y axial directions. The exposure apparatus EX moves a shot region of the substrate P in the Y axial directions with respect to the projection region AR of the projection optical system PL, and radiates the exposure light EL to the projection region AR through the projection optical system PL and the liquid LQ while moving the patterned region of the mask M in the Y axial directions with respect to an illumination region IA of the illumination system IL synchronized to the movement of the substrate P in the Y axial directions. Thereby, the shot region on the substrate P is exposed with the image of the pattern that is formed in the projection region AR.

The illumination system IL illuminates the prescribed illumination region IA on the mask M with the exposure light EL, which has a uniform luminous flux intensity distribution. Examples of light that can be used as the exposure light EL emitted from the illumination system IL include: deep ultraviolet (DUV) light, such as bright line (g-line, h-line, or i-line) light emitted from, for example, a mercury lamp and KrF excimer laser light (248 nm wavelength); and vacuum ultraviolet (VUV) light, such as ArF excimer laser light (193 nm wavelength) and F₂ laser light (157 nm wavelength). ArF excimer laser light is used in the present embodiment.

The mask stage 1, in a state wherein it holds the mask M, is movable in the X axial, Y axial, and θZ directions by the drive of a mask stage drive apparatus 1D, which comprises actuators such as linear motors. The mask stage 1 has an opening 1K in order to pass the exposure light EL therethrough during the exposure of the substrate P. The exposure light EL from the illumination system IL is radiated to the patterned surface Ms of the mask M. The exposure light EL from the patterned surface Ms of the mask M passes through the opening 1K of the mask stage 1 and then enters the projection optical system PL. Laser interferometers 1L measure the positional information of the mask stage 1 (the mask M). The laser interferometers 1L use reflecting surfaces 1R of movable mirrors (reflecting mirrors), which are provided on the mask stage 1, to measure the positional information of the mask stage 1. Based on the measurement result of the laser interferometers 1L, the control apparatus 3 controls the position of the mask M, which is held by the mask stage 1, by driving the mask stage drive apparatus 1D.

Furthermore, each of the movable mirrors (reflecting mirrors) used in positional measurement need not simply be a plane mirror, but may include a corner cube (retroreflector); furthermore, it is acceptable to use, for example, reflecting surfaces that are formed by mirror polishing end surfaces (side surfaces) of the mask stage 1, instead of providing the reflecting mirrors so that they are fixed to the mask stage. In addition, the mask stage 1 may be configured so that it is coarsely and finely movable, as disclosed in, for example, Japanese Patent Application Publication No. H8-130179A (corresponding U.S. Pat. No. 6,721,034).

The substrate stage 2 comprises a substrate holder 2H that holds the substrate P and, in a state wherein the substrate P is held by the substrate holder 2H, is movable on a base member 4 with six degrees of freedom, i.e., the X axial, Y axial, Z axial, θX, θY, and θZ directions, by the drive of a substrate stage drive apparatus 2D, which includes actuators such as linear motors. The substrate holder 2H of the substrate stage 2 holds the substrate P so that the front surface Ps thereof is substantially parallel to the XY plane. Laser interferometers 2L measure the positional information of the substrate stage 2 (the substrate P). The laser interferometers 2L use reflecting surfaces 2R, which are provided to the substrate stage 2, to measure the positional information of the substrate stage 2 in the X axial, Y axial, and θZ directions. In addition, the exposure apparatus EX comprises a focus and level detection system (not shown) that can detect the positional information (positional information in the Z axial, θX, and θY directions) of the front surface Ps of the substrate P, which is held by the substrate stage 2. The control apparatus 3 controls the position of the substrate P, which is held by the substrate stage 2, by driving the substrate stage drive apparatus 2D based on the measurement results of the laser interferometers 2L and the detection results of the focus and level detection system.

The focus and level detection system detects inclination information (the rotational angle) of the substrate P in the θX and the θY directions by measuring the positional information of the substrate P in the Z axial directions at the plurality of measurement points. Furthermore, if, for example, the laser interferometers 2L are capable of measuring the positional information of the substrate P in the Z axial, the θX, and the θY directions, then the focus and level detection system does not need to be provided so that the positional information of the substrate P can be measured in the Z axial directions during the exposure operation, and the position of the substrate P in the Z axial, the θX, and the θY directions may be controlled using the measurement results of the laser interferometers 2L at least during the exposure operation.

In addition, in the present embodiment, the substrate stage 2 is provided with a recessed part 2C, wherein the substrate holder 2H is disposed. The upper surface 2F of the substrate stage 2 is flat. The upper surface 2F of the substrate stage 2 is disposed around the recessed part 2C of the substrate holder 2H so that it is substantially the same height as (is flush with) the front surface Ps of the substrate P, which is held by the substrate holder 2H.

The following explains the projection optical system PL. The projection optical system PL projects an image of the pattern that is formed on the patterned surface Ms of the mask M to the front surface Ps of the substrate P at a prescribed projection magnification. In the present embodiment, the projection optical system PL projects an image of the pattern of the mask M to the front surface Ps of the substrate P through the liquid LQ of the immersion space LS. The projection optical system PL has the plurality of optical elements, which are held by a holding mechanism 7 that includes a lens barrel 5 and holding members 6. The projection optical system PL of the present embodiment is a reduction system, the projection magnification of which is, for example, ¼, ⅕, or ⅛, and forms a reduced image of the pattern of the mask M in the projection region AR, which is optically conjugate with the illumination region IA discussed above. Furthermore, the projection optical system PL may be a reduction system, a unity magnification system, or an enlargement system. In addition, the projection optical system PL may be: a dioptric system that does not include catoptric elements; a catoptric system that does not include dioptric elements; or a catadioptric system that includes both catoptric elements and dioptric elements. In addition, the projection optical system PL may form either an inverted image or an erect image.

In the present embodiment, an optical axis AX of the projection optical system PL, which includes the optical element 10, is substantially parallel to the Z axis. In addition, the image plane Is of the projection optical system PL is substantially parallel to the XY plane. The control apparatus 3 projects an image of the pattern of the mask M to the front surface Ps of the substrate P through the projection optical system PL and the liquid LQ of the immersion space LS while adjusting the positional relationship between the image plane Is of the projection optical system PL and the front surface (exposure surface) Ps of the substrate P, which is held by the substrate stage 2.

In the present embodiment, an optical path space on the side of the optical element 10 that is toward the image plane Is of the projection optical system PL is filled with the liquid LQ, and a lower surface (an emergent surface 12) of the optical element 10 contacts the liquid LQ of the immersion space LS. In addition, in the present embodiment, the space that includes the optical path through which the exposure light EL travels on the side of the optical element 10 that is toward the object plane Os of the projection optical system PL, i.e., a prescribed space 70 on the object plane Os side of the optical element 10 that is formed inside the lens barrel 5, is filled with a gas G1 and not the liquid LQ. Namely, an upper surface (an incident surface 11) of the optical element 10 contacts the gas G1.

The exposure apparatus EX comprises a first gas supply apparatus 40, which supplies the gas G1 to the prescribed space 70 inside the lens barrel 5. The control apparatus 3 controls the first gas supply apparatus 40.

The optical element 10, which is the optical element of the plurality of optical elements of the projection optical system PL that is disposed at the position that is closest to the image plane Is of the projection optical system PL, comprises an incident surface 11, through which the exposure light EL from the patterned surface Ms enters, and an emergent surface 12, from which the exposure light EL that enters from the incident surface 11 emerges. The incident surface 11 is a convexly curved surface that faces and protrudes toward the patterned surface Ms (the object plane Os of the projection optical system PL). In the present embodiment, the emergent surface 12 of the optical element 10 is a flat surface that is substantially parallel to the XY plane (the image plane Is of the projection optical system PL) and is disposed so that it opposes the front surface Ps of the substrate P. In addition, as discussed above, the substrate holder 2H of the substrate stage 2 holds the substrate P so that the front surface Ps of the substrate P is substantially parallel to the XY plane, and therefore the emergent surface 12 of the optical element 10 and the front surface Ps of the substrate P held by the substrate stage 2 are substantially parallel.

Filling the optical path space K of the exposure light EL with the liquid LQ, which has a refractive index with respect to the exposure light EL that is higher than that of, for example, air, makes it possible to implement an projection optical system PL that has a large numerical aperture NA while making the exposure light EL reach the front surface Ps of the substrate P (the image plane Is of the projection optical system PL). The numerical aperture NA of the projection optical system PL on the image plane Is side is expressed by the following equation:

Na=n·sin θ (1)

In equation (1), n is the refractive index of the liquid LQ and θ is the convergence half-angle. In addition, the following equations express the resolution R and the depth of focus δ, respectively.

R=k₁·λ/NA (2)

δ=±k₂·λ/NA² (3)

In equations (2) and (3), λ is the exposure wavelength and k₁, k₂ are process coefficients. As expressed in equations (2) and (3), the liquid LQ, which has a high refractive index (n), increases the numerical aperture NA by approximately n times, which makes it possible to improve resolution and depth of focus significantly.

In the present embodiment, the refractive index of the liquid LQ, which fills the optical path space K of the exposure light EL, with respect to the exposure light EL (ArF excimer laser light with a wavelength of 193 nm) is higher than that of the optical element 10. If, for example, the optical element 10 is made of silica glass, which has a refractive index of approximately 1.56 with respect to the exposure light EL, then the liquid used as the liquid LQ is one that has a refractive index, e.g., approximately 1.6-1.8, with respect to the exposure light EL that is higher than that of silica glass.

In the present embodiment, the optical element 10 is formed from silica glass (SiO₂), and decalin (C₁₀H₁₈) is used as the liquid LQ. As discussed above, the refractive index of silica glass with respect to the exposure light EL is approximately 1.56, and the refractive index of decalin with respect to the exposure light EL is higher than that of silica glass. For example, the refractive index of water (pure water) with respect to the exposure light EL is approximately 1.44, and the refractive index of decalin with respect to the exposure light EL is higher than that of water (pure water). In addition, in the present embodiment, the numerical aperture NA of the projection optical system PL is, for example, approximately 1.4, which is less than the refractive index of the optical element 10 with respect to the exposure light EL.

Furthermore, for example, barium lithium fluoride (BaLiF₃), which has a refractive index of approximately 1.64 with respect to the exposure light EL, can also be used as the material with which the optical element 10 is formed. In addition, fluorite (CaF₂), barium fluoride (BaF₂), or some other monocrystalline material of a fluorine compound can also be used as the material with which the optical element 10 is formed. In addition, for example, it is possible to use sapphire, germanium dioxide, or the like as disclosed in PCT International Publication WO2005/059617, or potassium chloride (which has a refractive index of approximately 1.75) or the like as disclosed in PCT International Publication WO2005/059618.

As discussed above, the space 70 on the side of the optical element 10 that is toward the patterned surface Ms of the mask M (the +Z side in the figure) is filled with the gas G1, and the space on the side of the optical element 10 that is toward the front surface Ps of the substrate P (the −Z side in the figure) is filled with the liquid LQ. In addition, the incident surface 11 of the optical element 10 is disposed so that it faces the patterned surface Ms of the mask M (in the +Z direction), and the emergent surface 12 of the optical element 10 is disposed so that it faces the front surface Ps of the substrate P (in the −Z direction). The incident surface 11 of the optical element 10 is a convexly curved surface that faces the patterned surface Ms, and therefore all light rays that form an image on the front surface Ps of the substrate P (in the image plane Is of the projection optical system PL) can enter the incident surface 11. In addition, the emergent surface 12 of the optical element 10 is shaped similarly to the incident surface 11 so that all of the light rays that form an image on the front surface Ps of the substrate P can emerge.

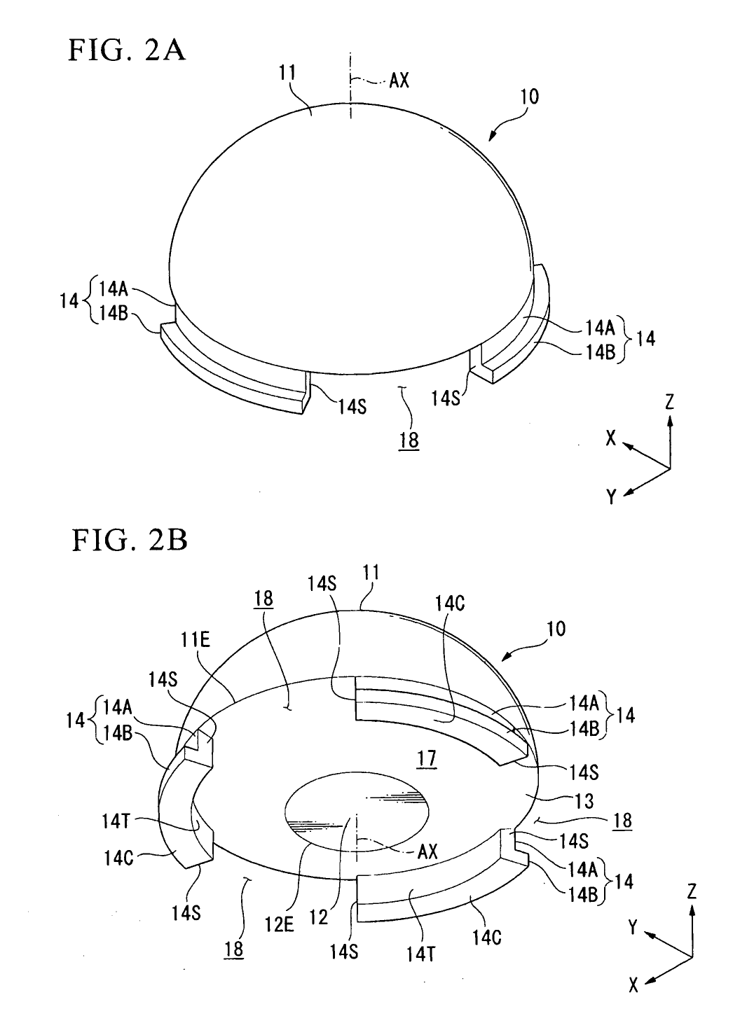

FIGS. 2A and 2B show the optical element 10. FIG. 2A is an oblique view, viewed from the incident surface 11 side, and FIG. 2B is an oblique view, viewed from the emergent surface 12 side. In FIGS. 2A and 2B, the optical element 10 comprises: the incident surface 11, which is a convexly shaped surface that faces the +Z side; the emergent surface 12; an outer circumferential surface 13, which connects an outer circumference 11E of the incident surface 11 and an outer circumference 12E of the emergent surface 12; and holding parts 14, which are formed so that they project toward the −Z side (the substrate P) at a circumferential edge part of the outer circumferential surface 13. In the present embodiment, the emergent surface 12 is substantially circular when viewed from the −Z side. The outer circumferential surface 13 can include a transition surface between the incident surface 11 and the emergent surface 12. In the present embodiment, the outer circumferential surface 13 is annularly shaped such that it surrounds the emergent surface 12, viewed from the −Z side. The holding parts 14 are portions that are held by the holding members 6 of the holding mechanism 7. The holding members 6 are connected to a lower end of the lens barrel 5 (refer to FIG. 1).

Furthermore, the lens barrel 5 and the holding members 6 may be integrally formed. The holding parts 14 are formed at a plurality of locations of the circumferential edge part of the outer circumferential surface 13 so that they are spaced apart from one another. In the present embodiment, the holding parts 14 are formed at three locations of the circumferential edge part of the outer circumferential surface 13 so that they are spaced apart from one another at substantially equal intervals (at approximately 120° intervals) in the circumferential directions of the outer circumferential surface 13 (the optical path space K). Each of the holding parts 14 comprises: a first portion 14A, which is formed so that it projects toward the substrate P side (the −Z side) from the circumferential edge part of the outer circumferential surface 13; and a second portion 14B, which is formed in a lower end of the corresponding first portion 14A and so that it projects toward the outer side of the first portion 14A with respect to the optical axis AX in the X or Y directions. In the present embodiment, the emergent surface 12 and a lower surface 14C of each of the holding parts 14 are formed so that they are at substantially the same position (height) in the Z axial directions when the optical element 10 is held by the holding members 6.

Furthermore, the emergent surface 12 and the lower surfaces 14C of the holding parts 14 may be formed so that they are at different positions (heights) in the Z axial directions.

When the optical element 10 is held by the holding members 6, the outer circumferential surface 13 is disposed at a position at which it is more spaced apart from the front surface Ps of the substrate P than the emergent surface 12 is. Namely, the distance between the outer circumferential surface 13 and the front surface Ps of the substrate P is greater than the distance between the emergent surface 12 and the front surface Ps of the substrate P. In the present embodiment, the outer circumferential surface 13 of the optical element 10 is an inclined surface that inclines from the emergent surface 12 (the XY plane) to the incident surface 11 side (the +Z side). Namely, the outer circumferential surface 13 is inclined with respect to the emergent surface 12 so that its distance to the front surface Ps of the substrate P increases. The outer circumferential surface 13 is inclined so that its distance to the front surface Ps of the substrate P increases as its distance from the emergent surface 12, where through the optical axis AX of the optical element 10 passes, toward the outer side increases.

Furthermore, a first space 17 is formed between the outer circumferential surface 13 and each of the holding parts 14 in the directions (the X and Y directions) that are perpendicular to the optical axis AX (the Z axis) of the optical element 10. Each of the first spaces 17 is a space that is formed on the outer side of the emergent surface 12 with respect to the optical axis AX between the outer circumferential surface 13 and an inner side surface 14T of the corresponding holding part 14, and is formed radially with respect to the optical axis AX. In the present embodiment, the first spaces 17 are formed around the optical axis AX at three locations in the circumferential directions in accordance with the holding parts 14 that are formed at three locations.

In addition, second spaces 18 are formed between adjacent first spaces 17. Each of the second spaces 18 is a space that is formed radially with respect to the optical axis AX on the outer side of the emergent surface 12 with respect to the optical axis AX, and include the spaces between side surfaces 14S of adjacent holding parts 14. In addition, the second spaces 18 are formed so that they connect to an external space on the outer side of the outer circumference 11E of the incident surface 11 with respect to the optical axis AX.

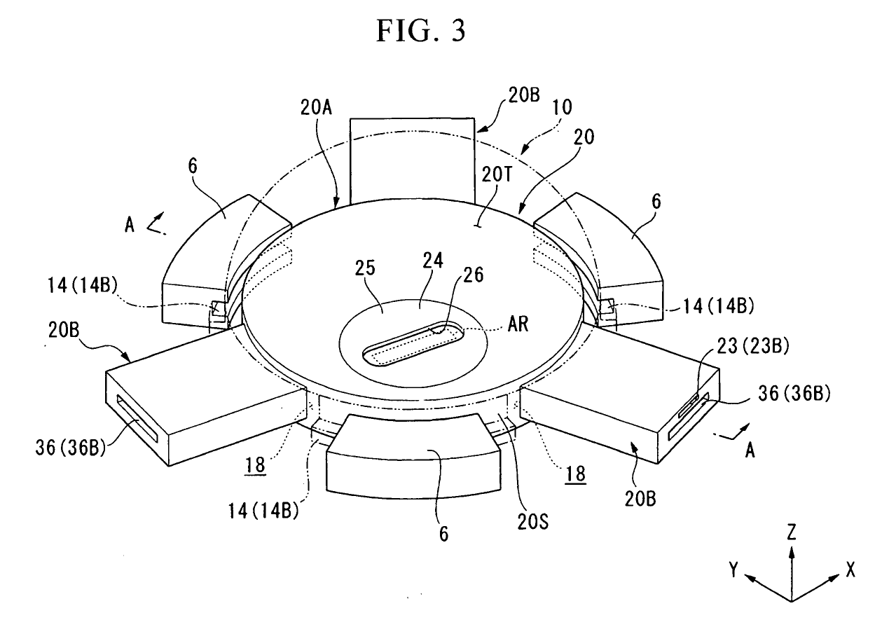

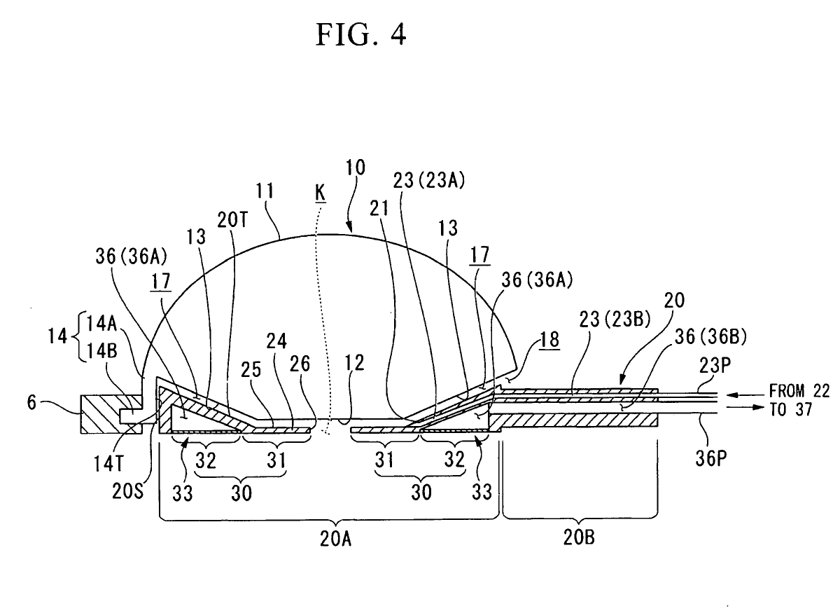

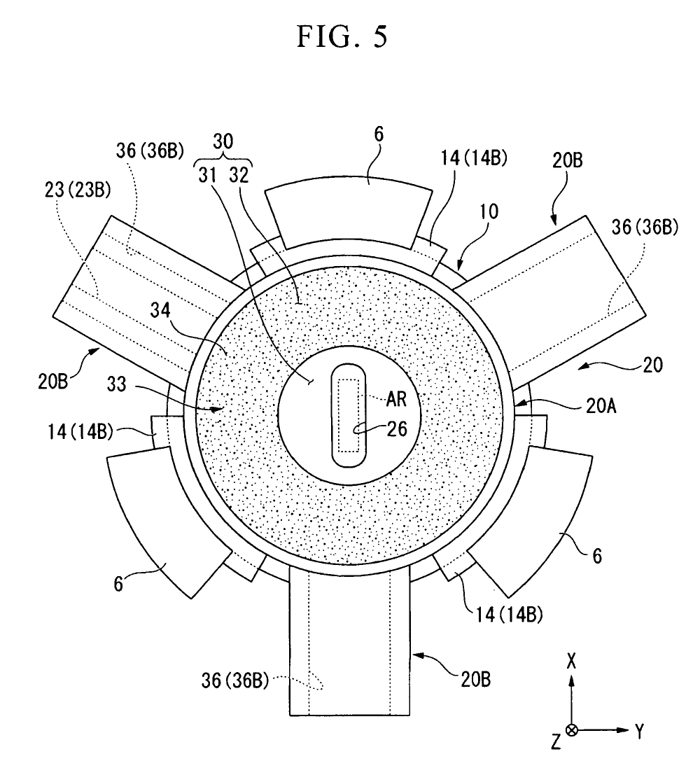

The following explains the holding members 6, which hold the optical element 10, and the nozzle member 20, referencing FIG. 3 through FIG. 5. FIG. 3 is an oblique view that shows the vicinity of the optical element 10, which is held by the holding members 6, and FIG. 4 is a side cross sectional view that shows the vicinity of the optical element 10, which is held by the holding members 6, and corresponds to a cross sectional auxiliary view taken along the A-A line of FIG. 3. In addition, FIG. 5 is a plan view of FIG. 3, viewed from the −Z side.

The holding members 6 of the holding mechanism 7 hold the optical element 10 by holding the holding parts 14 of the optical element 10. The holding members 6 are disposed on the outer sides of the holding parts 14 of the optical element 10 with respect to the optical axis AX. The holding members 6 are disposed spaced apart from one another at the plurality of locations (three locations in the present embodiment) at which the holding parts 14 of the optical element 10 are disposed so that they correspond to the plurality of holding parts 14 of the optical element 10. Each of the holding members 6 holds the second portion 14B of the corresponding holding part 14, which is formed in the lower end of the optical element 10, so that it sandwiches the second portion 14B.

The nozzle member 20 comprises a liquid supply port 21, which supplies the liquid LQ in order to form the immersion space LS, and a liquid recovery port 33, which recovers the liquid LQ. The nozzle member 20 is held by a prescribed support mechanism (not shown). In addition, in the present embodiment, the nozzle member 20 and the optical element 10 are spaced apart.

The nozzle member 20 is disposed in the vicinity of the optical element 10 so that it opposes the front surface Ps of the substrate P (and/or the upper surface 2F of the substrate stage 2). At least one part of the nozzle member 20 is disposed in the first spaces 17. In addition, at least one part of the nozzle member 20 is disposed in the second spaces 18. In the present embodiment, the holding members 6, which hold the holding parts 14, and parts of the nozzle member 20 are alternately disposed around the optical element 10.

The nozzle member 20 comprises a main body portion 20A, which can be disposed in the first spaces 17 and the second spaces 18, and passageway portions 20B, which can be disposed on the outer sides of the second spaces 18 with respect to the optical axis AX. The main body portion 20A is an annular member and is disposed above the substrate P (the substrate stage 2) (on the −Z side of the optical element 10) around the optical path space K of the exposure light EL. The liquid supply port 21 and the liquid recovery port 33 are disposed in the main body portion 20A. Three passageway portions 20B are provided so that they correspond to the plurality (three) of the second spaces 18. For each of the passageway portions 20B, one end is connected to the main body portion 20A and the other end is disposed on the outer side of the corresponding second space 18 with respect to the optical axis AX (is in the external space).

The main body portion 20A of the nozzle member 20 has an inner side surface 20T that opposes the outer circumferential surface 13 of the optical element 10 and is formed so that it follows the outer circumferential surface 13. A prescribed gap is formed between the outer circumferential surface 13 of the optical element 10 and the inner side surface 20T of the nozzle member 20. In addition, the main body portion 20A of the nozzle member 20 has a side surface 20S, which opposes the inner side surfaces 14T of the holding parts 14 of the optical element 10 and is formed so that it follows the inner side surfaces 14T. A prescribed gap is formed between the inner side surface 14T of each holding part 14 and the side surface 20S of the nozzle member 20.

The main body portion 20A of the nozzle member 20 has a lower surface 30 that opposes the front surface of the substrate P. The lower surface 30 of the nozzle member 20 has a first surface 31, which is disposed around the optical path space K of the exposure light EL, and a second surface 32, which is disposed around the first surface 31 on the outer side thereof with respect to the optical path space K of the exposure light EL. The lower surface 30 of the nozzle member 20 can hold the liquid LQ between itself and the front surface of the substrate P, and is capable of forming part of the immersion space LS of the liquid LQ between itself and the front surface of the substrate P.

The first surface 31 is a flat surface and is disposed so that it is substantially parallel to the front surface of the substrate P (the XY plane). At least part of the first surface 31 is disposed between the emergent surface 12 of the optical element 10 and the front surface Ps of the substrate P so that it surrounds the optical path space K of the exposure light EL. The first surface 31 is disposed at the position of the nozzle member 20 that is closest to the substrate P, which is held by the substrate stage 2, and is lyophilic with respect to the liquid LQ (the liquid LQ has a contact angle therewith off less than 60°). Accordingly, the first surface 31 is capable of holding the liquid LQ satisfactorily between itself and the front surface Ps of the substrate P.

Furthermore, the position of the first surface 31 and the position of the second surface 32 of the lower surface 30 of the nozzle member 20 may be different in the Z axial directions. For example, the second surface 32 may be disposed at a position that is higher than (on the +Z side of) the first surface 31.

The main body portion 20A of the nozzle member 20 comprises a bottom plate 24, which has an upper surface 25 that opposes part of the region of the emergent surface 12 of the optical element 10. Part of the bottom plate 24 is disposed between the emergent surface 12 of the optical element 10 and the substrate P (the substrate stage 2) in the Z axial directions. A prescribed gap is provided between the emergent surface 12 of the optical element 10 and the upper surface 25 of the bottom plate 24. The first surface 31 includes the lower surface of the bottom plate 24 that opposes the front surface Ps of the substrate P.

An opening 26, through which the exposure light EL passes, is formed in the center of the bottom plate 24. The first surface 31 is provided to the bottom plate 24 so that it surrounds the opening 26, wherethrough the exposure light EL passes. In the present embodiment, the external shape of the first surface 31 is substantially circular when viewed from the −Z side, and the opening 26 is formed at substantially the center of the first surface 31. In the present embodiment, the cross sectional shape of the exposure light EL in the vicinity of the image plane Is, i.e., the projection region AR, is substantially rectangular (slit shaped) with the longitudinal directions set in the X axial directions, and the opening 26 is formed substantially rectangularly in the X and Y directions in accordance with the cross sectional shape of the exposure light EL.

The liquid supply port 21 is connected to a space in the main body portion 20A of the nozzle member 20 that is between the emergent surface 12 of the optical element 10 and the upper surface 25 of the bottom plate 24, and is capable of supplying the liquid LQ to that space. In the present embodiment, the liquid supply port 21 is provided at one prescribed location on the outer side of the optical path space K of the exposure light EL.

The second surface 32 (refer to FIG. 4 and FIG. 5) includes the surface at which the liquid LQ can be recovered. The liquid recovery port 33 is formed in the lower surface 30 of the main body portion 20A of the nozzle member 20 around the optical path space K of the exposure light EL. A space that opens downwardly is formed in the main body portion 20A of the nozzle member 20, and the liquid recovery port 33 is formed in the lower end of that opening. A porous member 34 is disposed in the liquid recovery port 33. The liquid recovery port 33 can recover the liquid LQ through the porous member 34, and the second surface 32 is formed by the lower surface of the porous member 34, which is disposed in the liquid recovery port 33. The porous member 34 that forms the second surface 32 is a mesh member, wherein a plurality of through holes are formed in a plate shaped member, and is lyophilic with respect to the liquid LQ. Furthermore, the porous member 34 is not limited to a plate shaped mesh member, and may be, for example, a sintered member (e.g., sintered metal) or a foam member (e.g., a metal foam) wherein multiple holes are formed that hydraulically connect the upper surface and the lower surface of the porous member 34.

The second surface 32, which includes the liquid recovery port 33, is disposed on the outer side of the liquid supply port 21 with respect to the optical path space K of the exposure light EL (the opening 26). In the present embodiment, the second surface 32 is annularly shaped when viewed from the −Z side and has a prescribed width in the radial directions with respect to the optical axis AX. The second surface 32 is capable of holding the liquid LQ between itself and the front surface Ps of the substrate P, and is capable of forming part of the immersion space LS of the liquid LQ between itself and the front surface of the substrate P.

In the present embodiment, the second surface 32 (the lower surface of the porous member 34) is substantially flat and is substantially flush with the first surface 31. In the present embodiment, the lower surfaces of the holding members 6 that oppose the front surface Ps of the substrate P and the lower surface 30 of the nozzle member 20, including the first surface 31 and the second surface 32, are disposed at substantially the same position (height) in the Z axial directions.

Furthermore, the position of the lower surfaces of the holding members 6 and the position of the lower surface 30 of the nozzle member 20 may be different in the Z axial directions. For example, the positions of the lower surfaces of the holding members 6 may be higher than (on the +Z side of) the position of the lower surface 30 of the nozzle member 20.

The liquid supply port 21 is connected to a liquid supply apparatus 22 via a supply passageway 23, which is formed inside the nozzle member 20, and a supply pipe 23P. The liquid supply apparatus 22 is capable of feeding the pure, temperature adjusted liquid LQ. The supply passageway 23 comprises a first portion 23A, which is formed in the main body portion 20A, and a second portion 23B, which is formed in one of the three passageway portions 20B. The liquid supply apparatus 22 is capable of supplying the liquid LQ for forming the immersion space LS via the supply pipe 23P, the supply passageway 23 (23A, 23B), and the liquid supply port 21. The control apparatus 3 controls the operation of the liquid supply apparatus 22.

The liquid recovery port 33 is connected to a liquid recovery apparatus 37 via a recovery passageway 36, which is formed inside the nozzle member 20, and recovery pipes 36P. The liquid recovery apparatus 37 comprises, for example, a vacuum system and is capable of recovering the liquid LQ. The recovery passageway 36 comprises a first portion 36A, which is formed in the main body portion 20A, and three second portions 36B, which are respectively formed in the three passageway portions 20B. As discussed above, a space that opens downwardly is formed in the main body portion 20A of the nozzle member 20, and the first portion 36A includes this space. In addition, the second portions 36B, each of which is formed in its corresponding passageway portion 20B of the plurality of passageway portions 20B, are connected to the first portion 36A. The liquid recovery apparatus 37 is capable of recovering the liquid LQ of the immersion space LS through the liquid recovery port 33, the recovery passageway 36 (36A, 36B), and the recovery pipes 36P. The control apparatus 3 controls the operation of the liquid recovery apparatus 37.

Furthermore, it is possible to form an exhaust port at a prescribed position of the nozzle member 20 that discharges (exhausts) the gas in the space between the emergent surface 12 of the optical element 10 and the upper surface 25 of the bottom plate 24 and in the vicinity of that space to the external space (including the atmospheric space).

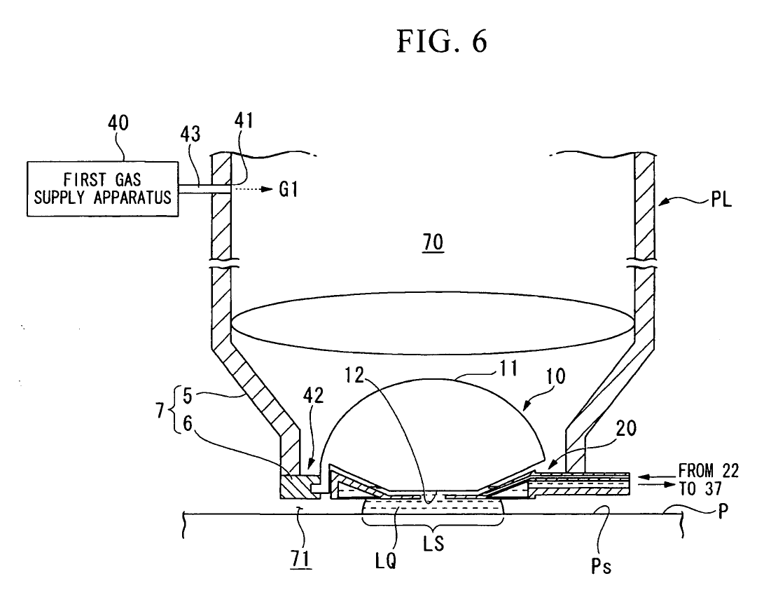

FIG. 6 is a partial cross sectional view of the projection optical system PL. The exposure apparatus EX comprises: a first gas supply port 41, which supplies the gas G1 to the prescribed space 70 on the incident surface 11 side (the patterned surface Ms side) of the optical element 10, which is disposed inside the lens barrel 5; and a gas passageway 42, which is in communication with the prescribed space 70 and at least part of a gas space 71, which surrounds the immersion space LS, so that the gas G1 that is supplied via the first gas supply port 41 contacts the liquid LQ of the immersion space LS. In the present embodiment, the first gas supply port 41 is formed in part of an inner wall surface of the lens barrel 5. The first gas supply port 41 is connected to the first gas supply apparatus 40 via a passageway 43. The first gas supply apparatus 40 is capable of supplying the gas G1 to the prescribed space 70 via the passageway 43 and the first gas supply port 41. Furthermore, in the present embodiment, other optical elements are disposed between the first gas supply port 41 and the optical element 10, but the first gas supply port 41 may be provided so that the gas G1 is blown out toward the space between the optical element 10 and another optical element that is adjacent to the optical element 10.

The control apparatus 3 controls the operation of the first gas supply apparatus 40. The control apparatus 3 supplies the gas G1 to the prescribed space 70 via the first gas supply port 41 by controlling the first gas supply apparatus 40, thereby filling the prescribed space 70 with the gas G1. The gas G1 includes an inert gas. The inert gas includes nitrogen. In the present embodiment, the first gas supply apparatus 40 supplies gas that has a nitrogen concentration of substantially 100%. Thereby, the prescribed space 70 is filled with the gas that has a nitrogen concentration of substantially 100%. Furthermore, the gas (inert gas) G1 that fills the prescribed space 70 may be helium or a gas mixture of nitrogen and helium, or the gas mixture disclosed in Japanese Patent Application Publication No. 2002-110538A (corresponding U.S. Pat. No. 6,747,729) may be used.

The holding members 6 hold the optical element 10 so that the gas passageway 42 is formed. In the present embodiment, the gas passageway 42 is provided on the outer side of the liquid recovery port 33 (outer side of the immersion space LS) with respect to the optical path space K of the exposure light EL. As discussed above, the holding members 6 are disposed at a plurality of locations (three locations) in accordance with the holding parts 14 of the optical element 10 and are spaced apart from one another so that they surround the optical element 10. Gaps are formed between the plurality of holding members 6 (holding parts 14) and the plurality of passageway portions 20B of the nozzle member 20, and the gas passageway 42 includes these gaps. The gas G1 that is supplied to the prescribed space 70 is supplied to the gas space 71, which surrounds the immersion space LS, through the gas passageway 42. Furthermore, the amount of the gas G1 that is supplied to the prescribed space 70 is adjusted so that there is no flow of gas from the gas space 71 toward the prescribed space 70.

The following explains a method of exposing the image of the pattern of the mask M onto the substrate P using the exposure apparatus EX having a constitution as discussed above.

The control apparatus 3 operates both the liquid supply apparatus 22 and the liquid recovery apparatus 37 in order to fill the optical path space K of the exposure light EL with the liquid LQ continuously. The liquid LQ that is fed from the liquid supply apparatus 22 flows through the supply passageway 23 of the nozzle member 20, after which it is supplied to the space between the emergent surface 12 of the optical element 10 and the upper surface 25 of the bottom plate 24 via the liquid supply port 21. The liquid LQ that is supplied to the space between the emergent surface 12 of the optical element 10 and the upper surface 25 of the bottom plate 24 flows into the space between the lower surface 30 of the nozzle member 20 and the substrate P (the substrate stage 2) via the opening 26 and forms the immersion space LS so that it fills the optical path space K of the exposure light EL. The liquid LQ of the space between the lower surface 30 of the nozzle member 20 and the front surface Ps of the substrate P flows into the recovery passageway 36 via the second surface 32, which includes the liquid recovery port 33 of the nozzle member 20, flows through the recovery passageway 36, and is then recovered by the liquid recovery apparatus 37.

The control apparatus 3 forms the immersion space LS so that the optical path space K of the exposure light EL between the optical element 10 and the front surface Ps of the substrate P is filled with the liquid LQ by supplying a prescribed quantity of the liquid LQ per unit of time to the optical path space K of the exposure light EL via the liquid supply port 21 and recovering a prescribed quantity of the liquid LQ per unit of time via the liquid recovery port 33. Furthermore, the control apparatus 3 projects an image of the pattern of the mask M onto the substrate P through the projection optical system PL and the liquid LQ of the immersion space LS while moving the projection optical system PL and the substrate P relative to one another in a state wherein the optical path space K of the exposure light EL is filled with the liquid LQ. In the present embodiment, the exposure apparatus EX is a scanning type exposure apparatus wherein the scanning directions are set to the Y axial directions, and the control apparatus 3 controls the substrate stage 2 so as to perform a scanning exposure of each of a plurality of shot regions of the substrate P while moving the substrate P in one of the Y axial directions at a prescribed speed.

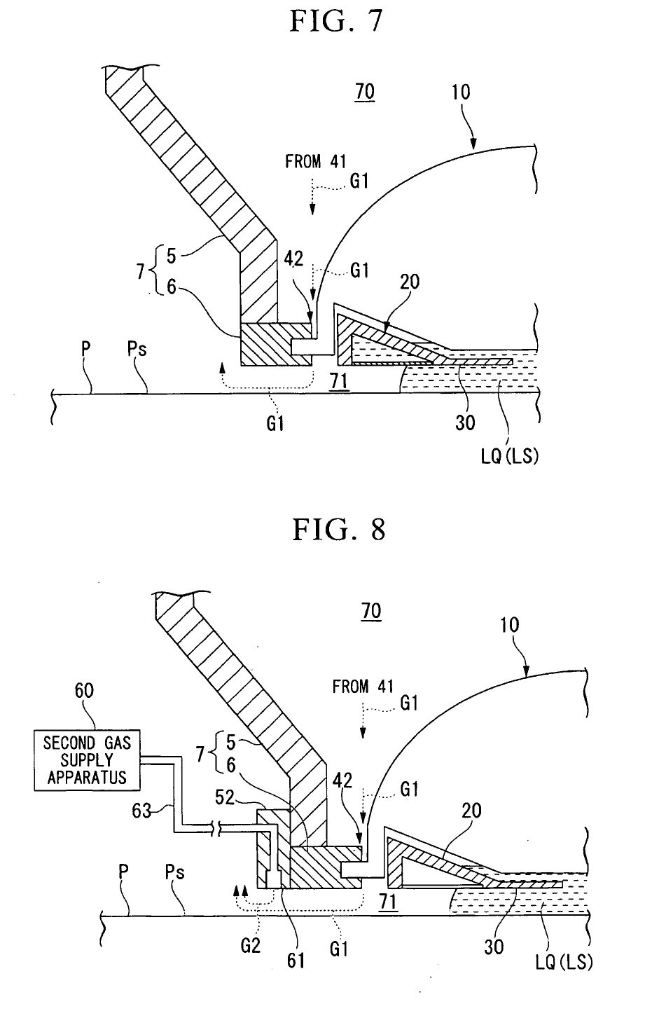

In addition, in the present embodiment, the first gas supply apparatus 40 fills the prescribed space 70 with the gas (inert gas) G1. As shown in the schematic drawing of FIG. 7, the gas G1 of the prescribed space 70 is supplied to the gas space 71, which surrounds the immersion space LS, through the gas passageway 42, which is formed in the vicinity of the holding members 6 (the holding parts 14). Thereby, the liquid LQ of the immersion space LS contacts the gas G1 that is supplied from the prescribed space 70 through the gas passageway 42. The control apparatus 3 exposes the substrate P while bringing the liquid LQ of the immersion space LS and the gas G1 into contact with one another.

As explained above, in the present embodiment, the holding parts 14 are formed at the circumferential edge part of the outer circumferential surface 13 of the optical element 10 so that they protrude toward the front surface Ps side of the substrate P, and are held by the holding members 6. At least part of the nozzle member 20 is disposed in the first spaces 17, which are formed between the holding parts 14 and the outer circumferential surface 13, and the second spaces 18, which are formed between adjacent first spaces 17. As a result, in the present embodiment, the space that surrounds the optical element 10 can be utilized effectively, which makes it possible to prevent the size of the apparatus from increasing.

For example, if holding parts (flanges) are formed on the side surfaces of an optical element so that they protrude from those side surfaces toward the outer side (in the X and Y directions) thereof and are held by holding members, then there is a possibility that the size of the peripheral members that are disposed in the vicinity of the optical element will need to be increased and that the degrees of freedom in disposing the holding members, the peripheral members, and the like will decrease, and there is also a possibility that the size of the entire exposure apparatus will increase. In particular, in the case wherein a liquid with a high refractive index is used with the aim of achieving a projection optical system with a large numerical aperture as in the present embodiment, if the incident surface of the optical element is a convexly curved surface that faces the patterned surface so that all of the light rays that form an image on the front surface of the substrate can enter it, then it becomes necessary to dispose the holding parts of the optical element and the holding members that hold the holding parts at positions that are near the substrate so that they do not interfere with the entry of the light rays. In this case, in order to prevent interference (contact) between the holding parts (holding members) and the nozzle member from occurring as a result of the structure of the holding parts (holding members) and the nozzle member that is disposed in the vicinity thereof, there is a possibility that the nozzle member will have to be disposed on the outer sides of the holding parts (the holding members), which would necessitate an increase in the size of the nozzle member. In addition, there is a possibility that the entire exposure apparatus will increase in size commensurate with the increased size of the nozzle member. In addition, if the size of the nozzle member increases, then there is a possibility that, for example, the immersion region formed on the substrate will increase in size, thereby making it difficult to form the immersion space between the optical element and the front surface of the substrate smoothly.

In the present embodiment, the holding parts 14 are formed at the circumferential edge part of the outer circumferential surface 13 of the optical element 10 so that they protrude toward the front surface Ps side (the −Z side) of the substrate P, and are held by the holding members 6. In addition, at least part of the nozzle member 20 is disposed in the plurality of first spaces 17, which are defined between the inner sides of the holding parts 14 and the outer circumferential surface 13, and in the second spaces 18, which are formed between adjacent first spaces 17. As a result, it is possible to guide all of the light rays for forming the image on the front surface of the substrate P from the incident surface 11 to the emergent surface 12 of the optical element 10, and thereby to expose the substrate P satisfactorily through the liquid LQ, while preventing the size of, for example, the nozzle member 20 from increasing.

In addition, in the present embodiment, it is possible to reduce the size of the immersion space LS in the X and Y directions (the size of the immersion region that is formed on the substrate P) commensurate with the decrease in the size of the nozzle member 20. Accordingly, it is possible to decrease the size of the substrate stage 2. In addition, because the size of the immersion space LS can be decreased, if the immersion space LS is formed on a specific shot region of the plurality of shot regions on the substrate P in order to expose that specific shot region, then it is possible to prevent other shot regions from contacting the liquid LQ of the immersion space LS (from being wetted by the liquid LQ). It is advantageous for the immersion space LS to be small in a case wherein a short contact time between the front surface Ps of the substrate P and the liquid LQ is preferable in order to reduce the impact on the material film that forms the front surface Ps of the substrate P (e.g., a photosensitive material film, a protective film formed thereon, or an antireflection film).

In addition, in the present embodiment, the liquid LQ of the immersion space LS contacts the gas (inert gas) G1 that is supplied from the prescribed space 70 on the incident surface 11 side of the optical element 10 through the gas passageway 42. In the present embodiment, the gas G1 flows from the prescribed space 70 into the gas space 71 so that it surrounds the immersion space LS between the nozzle member 20 and the substrate P. Thereby, it is possible to expose the substrate P through the liquid LQ while preventing the physical properties of that liquid LQ from changing. In the present embodiment, decalin is used as the liquid LQ, and the interior of the chamber apparatus 100 is filled with air. Decalin has a physical property such that it absorbs (dissolves) oxygen in the air comparatively easily; consequently, if the decalin and the air (oxygen) contact one another, there is a possibility that the oxygen will dissolve in the decalin and that, for example, the refractive index of the decalin with respect to the exposure light EL will change. If the refractive index of the liquid LQ with respect to the exposure light EL changes, then there is a possibility that the radiation state of the exposure light EL with respect to the substrate P will change, and that the projection state of the image of the pattern will deteriorate. In the present embodiment, the gas (inert gas) G1 that is supplied from the first supply port 41 to the prescribed space 70 is supplied through the gas passageway 42 to the gas space 71, which surrounds the immersion space LS, so that the immersion space LS and the liquid LQ contact one another, and therefore that supplied gas (inert gas) G1 makes it possible to prevent the liquid LQ of the immersion space LS from contacting the air. Even if the decalin absorbs the inert gas (nitrogen), the change in the refractive index is small, which makes it possible to prevent the physical properties (the refractive index) of that liquid LQ from changing as a result of the supply of the inert gas around the liquid (decalin) LQ. In addition, the gas passageway 42 supplies the gas G1 to the gas space 71, which surrounds the immersion space LS, i.e., to the space that is slightly spaced apart from the outer side of the edge (air-liquid interface) of the immersion space LS. Accordingly, it is possible to prevent, for example, bubbles from forming in the liquid LQ of the immersion space LS as a result of the gas G1 that is supplied through the gas passageway 42.

In addition, in the present embodiment, part of the gas G1 of the prescribed space 70 is supplied through the gas passageway 42 to the gas space 71, which surrounds the immersion space LS. Thereby, it is possible to prevent, for example, the size or the complexity of the apparatus from increasing. If an apparatus that supplies the gas G1 (inert gas) to the space that surrounds the immersion space LS is newly provided and an attempt is made to fill the entire interior of the chamber apparatus 100 with the inert gas, then there is a possibility that it will lead to, for example, an increase in the size and complexity of the apparatus. In the present embodiment, it is possible to bring the environment of the gas space 71, which surrounds the immersion space LS, into a desired state while preventing, for example, the size and the complexity of the apparatus from increasing.

### Second Embodiment

The following explains a second embodiment. A characteristic feature of the second embodiment is that it provides a second gas supply port, which supplies the gas to at least part of the gas space 71, which surrounds the immersion space LS. In the explanation below, constituent parts that are identical or equivalent to those in the embodiment discussed above are assigned identical symbols, and the explanations thereof are therefore abbreviated or omitted.

FIG. 8 is an enlarged cross sectional view of part of the exposure apparatus EX according to the second embodiment. In the present embodiment, the same as in the first embodiment discussed above, the exposure apparatus EX comprises the gas passageway 42 that communicates with prescribed space 70 and the gas space 71, which surrounds the immersion space LS, so that the gas G1 that is supplied via the first gas supply port 41 contacts the liquid LQ of the immersion space LS. In the present embodiment, the exposure apparatus EX is further provided with a second gas supply port 61, which supplies a gas G2 to at least part of the gas space 71, which surrounds the immersion space LS.

The second gas supply port 61 is formed in an annular prescribed member 52, which is formed so that it surrounds the immersion space LS. The prescribed member 52 is connected to the lower end of the side surface of the lens barrel 5. In the present embodiment, the second gas supply port 61 is formed in the lower surface of the prescribed member 52, which opposes the front surface Ps of the substrate P, and is disposed so that it opposes the front surface Ps of the substrate P. The second gas supply port 61 is disposed in the lower surface of the prescribed member 52 so that it surrounds the immersion space LS. The second gas supply port 61 is disposed on the outer side of the gas passageway 42 with respect to the optical path space K of the exposure light EL (the immersion space LS). The second gas supply port 61 is formed in the shape of an annular slit. In the present embodiment, the lower surface of the prescribed member 52, the lower surfaces of the holding members 6, and the lower surface 30 of the nozzle member 20 are disposed so that they are at substantially the same position (height) in the Z axial directions.

Furthermore, the second gas supply port 61 of the prescribed member 52 does not have to be provided so that it surrounds the immersion space LS continuously, but it should be disposed so that it surrounds the immersion space LS at least partially.

In addition, the prescribed member 52 may be configured so that it is supported by the nozzle member 20.

In addition, the position of the lower surface of the prescribed member 52 may differ from at least one of the positions of the lower surfaces of the holding members 6 and the position of the lower surface 30 of the nozzle member 20 in the Z axial directions.

The second gas supply port 61 is connected to a second gas supply apparatus 60 through a passageway 63. The second gas supply apparatus 60 is capable of supplying the gas G2 directly to the gas space 71, which surrounds the immersion space LS, through the passageway 63 and via the second gas supply port 61. The control apparatus 3 controls the operation of the second gas supply apparatus 60.

The gas G2 that the second gas supply apparatus 60 supplies is an inert gas. In the present embodiment, the gas G1 that is supplied to the gas space 71, which surrounds the immersion space LS, through the gas passageway 42, and the gas G2 that is supplied to the gas space 71, which surrounds the immersion space LS, via the second gas supply port 61 are the same gas (nitrogen). Furthermore, the gas G1 that is supplied through the gas passageway 42 and the gas G2 that is supplied via the second gas supply port 61 may be different. For example, the gas G1 may be nitrogen and the gas G2 may be helium. Alternatively, the gas G1 and the gas G2 may be the same gas mixture or different gas mixtures.

The control apparatus 3 drives the first gas supply apparatus 40 and the second gas supply apparatus 60 at least during the exposure of the substrate P. As shown in the schematic drawing of FIG. 8, the gas G1, which is supplied to the prescribed space 70 by the first gas supply apparatus 40 via the first gas supply port 41, is supplied through the gas passageway 42 to the gas space 71, which surrounds the immersion space LS, so that it contacts the liquid LQ of the immersion space LS. In addition, the gas G2, which is fed from the second gas supply apparatus 60, is supplied to the gas space 71, which surrounds the immersion space LS, via the second gas supply port 61.

Thus, providing the second gas supply port 61, supplying the gas G1 to the gas space 71, which surrounds the immersion space LS, through the gas passageway 42, and supplying the gas G2 via the second gas supply port 61 makes it possible to control contact between the air (the oxygen) and the liquid LQ of the immersion space LS much more effectively.

### Third Embodiment

The following explains a third embodiment. The characteristic feature of the third embodiment is that it provides an exhaust port (suction port) for discharging (suctioning) the gas that flows from the prescribed space 70 on the incident surface 11 of the optical element 10 into the gas space 71, which surrounds the immersion space LS. In the explanation below, constituent parts that are identical or equivalent to those in the embodiments discussed above are assigned identical symbols, and the explanations thereof are therefore abbreviated or omitted.

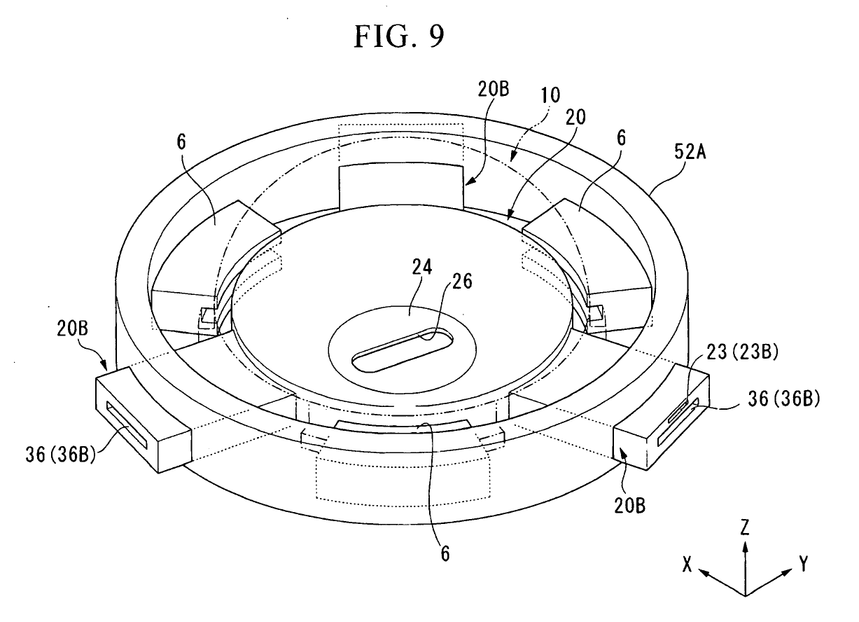

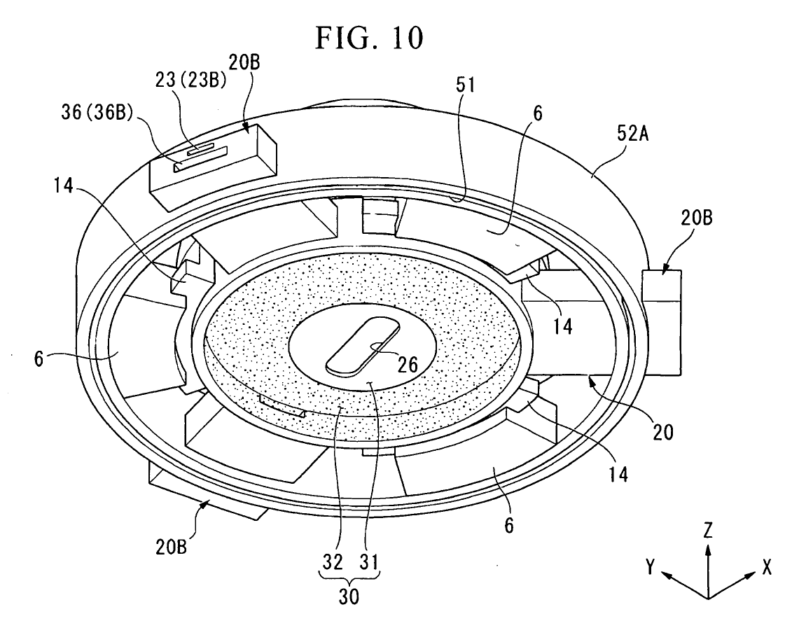

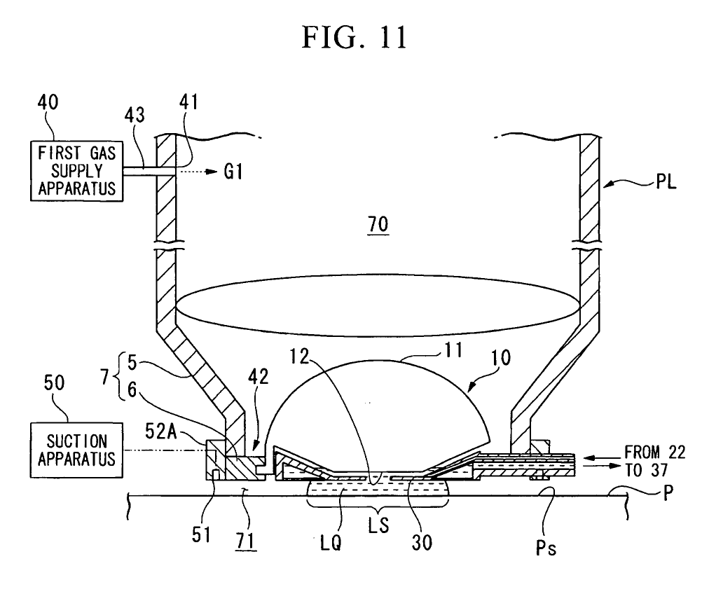

FIG. 9 is an oblique view that shows the vicinity of the optical element 10 according to the third embodiment, FIG. 10 is an oblique view of FIG. 9, viewed from the −Z side, and FIG. 11 is a side cross sectional view that shows the vicinity of the optical element 10. As shown in FIG. 9, FIG. 10, and FIG. 11, the exposure apparatus EX according to the third embodiment, similar to the first embodiment discussed above, comprises: the first gas supply port 41, which supplies the gas G1 to the prescribed space 70; and the gas passageway 42 that communicates with the prescribed space 70 and at least part of the gas space 71, which surrounds the immersion space LS, so that the gas G1 that is supplied via the first gas supply port 41 contacts the liquid LQ of the immersion space LS. Furthermore, in the present embodiment, the exposure apparatus EX comprises a prescribed member 52A, which has an exhaust port 51 for discharging the gas G1 that flows from the prescribed space 70 into the gas space 71, which surrounds the immersion space LS.

The prescribed member 52A is an annular member that is formed so that it surrounds the immersion space LS, and is supported by the passageway portions 20B of the nozzle member 20 in the present embodiment. In addition, as shown in FIG. 11, the prescribed member 52A is connected to the lower end of the side surface of the lens barrel 5.

Furthermore, similar to the second embodiment, the prescribed member 52A may be supported by the lens barrel 5.

The exhaust port 51 is formed in the lower surface of the prescribed member 52A, which opposes the front surface Ps of the substrate P, and is disposed so that it opposes the front surface Ps of the substrate P. The exhaust port 51 is disposed in the lower surface of the prescribed member 52A so that it surrounds the immersion space LS. The exhaust port 51 is disposed on the outer side of the gas passageway 42 with respect to the optical path space K of the exposure light EL (the immersion space LS). The exhaust port 51 is formed in the shape of an annular slit. In the present embodiment, the lower surface of the prescribed member 52A, the lower surfaces of the holding members 6, and the lower surface 30 of the nozzle member 20 are disposed so that they are at substantially the same position (height) in the Z axial directions.

Furthermore, the exhaust port 51 of the prescribed member 52A does not have to be provided so that it surrounds the immersion space LS continuously, but it should be disposed so that it surrounds the immersion space LS at least partially.

In addition, the position of the lower surface of the prescribed member 52A may differ from at least one of the positions of the lower surfaces of the holding members 6 and the position of the lower surface 30 of the nozzle member 20 in the Z axial directions.

A suction apparatus 50, which includes a vacuum system, is connected to the exhaust port 51 via a passageway. The suction apparatus 50 is capable of suctioning the gas via the exhaust port 51. The control apparatus 3 controls the operation of the suction apparatus 50.

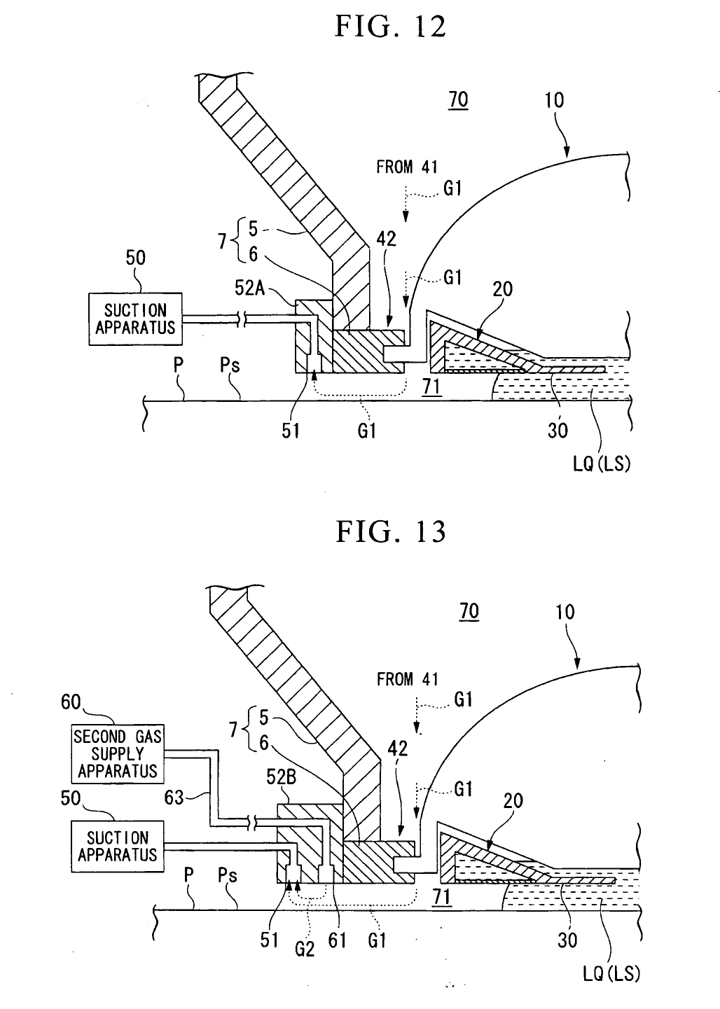

At least during the exposure of the substrate P, the control apparatus 3 performs the operation of supplying the gas G1 using the first gas supply port 41 and the operation of exhausting the gas G1 using the exhaust port 51 by driving the first gas supply apparatus 40 and the suction apparatus 50. As shown in the schematic drawing of FIG. 12, the gas G1 that is supplied to the prescribed space 70 on the incident surface 11 side of the optical element 10 via the first gas supply port 41 is supplied to the gas space 71, which surrounds the immersion space LS, through the gas passageway 42 so that it contacts the liquid LQ of the immersion space LS. By disposing the exhaust port 51 on the outer side of the gas passageway 42 with respect to the optical path space K of the exposure light EL and driving the suction apparatus 50, the gas G1 from the gas passageway 42 and the gas from the air conditioning unit 101 are discharged together via the exhaust port 51. Namely, the suction apparatus 50 suctions the inert gas from the gas passageway 42 and the air from the air conditioning unit 101 together via the exhaust port 51.

In the present embodiment, a flow of the gas G1 from the gas passageway 42 toward the exhaust port 51 is generated, and consequently the gas G1 is supplied from the prescribed space 70 to the gas space 71 efficiently. Accordingly, it is possible to control contact between the liquid LQ of the immersion space LS and the air much more effectively. In addition, discharging the gas G1 from the gas passageway 42 via the exhaust port 51 makes it possible to prevent that gas G1 from, for example, flowing into the optical paths of the measurement lights of the laser interferometers. The air conditioning unit 101 fills the interior of the chamber apparatus 100, which includes the optical paths of the measurement lights of the laser interferometers, with air; therefore, if the gas (inert gas) G1, which is different than the air, is supplied to the optical path of the measurement light of one of the laser interferometers, then there is a possibility that the difference in the refractive indexes of the air and the inert gas will lead to that laser interferometer making measurement errors. In the present embodiment, the exhaust port 51 is disposed so that it surrounds the gas passageway 42, which makes it possible to discharge the gas G1 from the gas passageway 42 satisfactorily and to prevent the gas G1 from flowing out to, for example, the optical paths of the measurement lights of the laser interferometers.

### Fourth Embodiment

The following explains a fourth embodiment. FIG. 13 is an enlarged cross sectional view of part of the exposure apparatus EX according to the fourth embodiment. In the explanation below, constituent parts that are identical or equivalent to those in the embodiment discussed above are assigned identical symbols, and the explanations thereof are therefore abbreviated or omitted.

As shown in FIG. 13, the exposure apparatus EX of the present embodiment comprises the gas passageway 42 that communicates with the prescribed space 70 on the incident surface 11 side of the optical element 10 and the gas space 71, which surrounds the immersion space LS, the second gas supply port 61, which supplies the gas G2 to at least part of the gas space 71, which surrounds the immersion space LS, and the exhaust port 51. The second gas supply port 61 is connected to the second gas supply apparatus 60 via the passageway 63 and is capable of supplying the gas (inert gas) G2 to the gas space 71, which surrounds the immersion space LS. The exhaust port 51 is connected to the suction apparatus 50 through a passageway, and is capable of exhausting the gases G1, G2.

The second gas supply port 61 and the exhaust port 51 are formed in a lower surface of an annular prescribed member 52B, which is formed so that it surrounds the immersion space LS. The second gas supply port 61 is disposed on the outer side of the gas passageway 42 with respect to the optical path space K of the exposure light EL (the immersion space LS). The exhaust port 51 is disposed on the outer side of the second gas supply port 61 with respect to the optical path space K of the exposure light EL (the immersion space LS).

Furthermore, a configuration may be adopted wherein the exhaust port 51 is disposed at a position at which it is closer to the optical path space K of the exposure light EL than the second gas supply port 61 is, and the gas that is supplied via the second gas supply port 61 flows toward the optical path space K of the exposure light EL.

Furthermore, the configurations of the second gas supply port 61 and the exhaust port 51 of the prescribed member 52B are the same as in the second and third embodiments discussed above, and detailed explanations thereof are therefore omitted.

Furthermore, the prescribed member 52B can be supported by the lens barrel 5 or the nozzle member 20.

In addition, in the present embodiment as well, the position of the lower surface of the prescribed member 52B may be substantially the same as at least one of the positions of the lower surfaces of the holding members 6 and the position of the lower surface 30 of the nozzle member 20 in the Z axial directions, or it may be different.

At least during the exposure of the substrate P, the control apparatus 3 uses the first gas supply port 41 to perform the operation of supplying the gas G1 and uses the exhaust port 51 to perform the operation of exhausting the gas G1 by driving the first gas supply apparatus 40 and the suction apparatus 50. As shown in the schematic drawing of FIG. 13, the gas G1 that is supplied to the prescribed space 70 via the first gas supply port 41 is supplied to the gas space 71, which surrounds the immersion space LS, through the gas passageway 42. In addition, at least during the exposure of the substrate P, the control apparatus 3 supplies the gas G2 to the gas space 71, which surrounds the immersion space LS, via the second gas supply port 61 by driving the second gas supply apparatus 60. The control apparatus 3 discharges (suctions) the gases (inert gases) G1, G2 from the gas passageway 42 via the second gas supply port 61 and the gas from the air conditioning unit 101 via the exhaust port 51 together by driving the suction apparatus 50. In the present embodiment as well, it is possible to control contact between the air and the liquid LQ of the immersion space LS. In addition, it is also possible to prevent the gas G1 and the gas G2 from leaking out to the space on the outer side of the prescribed member 52B.

Furthermore, in the second, third, and fourth embodiments discussed above, the second gas supply port 61 and/or the exhaust port 51 may be disposed at a position at which it is closer to the optical path space K of the exposure light EL (the immersion space LS) than the gas passageway 42 is.

Furthermore, in the second, the third, and the fourth embodiments discussed above, the prescribed member 52 (52A, 52B) is supported by at least one of the nozzle member 20 and the lens barrel 5, but it may be spaced apart from the nozzle member 20 and the lens barrel 5. In addition, if the second gas supply port 61 is provided to the lower surface of the prescribed member 52, then a gas bearing may be formed between the lower surface of the prescribed member 52 and the front surface Ps of the substrate P by blowing out the gas via the second gas supply port 61. In this case, as in the fourth embodiment, the second gas supply port 61 and the exhaust port 51 may be used in parallel to form a gas bearing as disclosed in, for example, U.S. Patent Application Publication No. 2006/0023189A1.

In addition, in the second and fourth embodiments discussed above, the liquid LQ may be prevented from leaking using the gas from the second gas supply port 61. Namely, the gas from the second gas supply port 61 may be used as a gas seal, as disclosed in, for example, U.S. Patent Application Publication No. 2006/0023189A1. In this case as well, as in the fourth embodiment, the second gas supply port 61 and the exhaust port 51 may be used in parallel to form the gas seal, as disclosed in, for example, U.S. Patent Application Publication No. 2006/0023189A1.

In addition, in the third and fourth embodiments discussed above, the liquid LQ may be recovered via the exhaust port 51. Namely, the liquid LQ that leaks to the outer side of the liquid recovery port 33 with respect to the optical path of exposure light EL may be recovered via the exhaust port 51 without being recovered via the liquid recovery port 33 of the nozzle member 20. In this case, the provision of the second gas supply port 61 on the outer side of the exhaust port 51 makes it possible to more reliably recover the liquid LQ that leaks to the outer side of the liquid recovery port 33 with respect to the optical path of the exposure light EL via the exhaust port 51.

Furthermore, in the first through fourth embodiments discussed above, the holding parts 14 of the optical element 10 and the holding members 6 that hold the holding parts 14 are disposed at substantially equal intervals in the circumferential directions of the optical path space K (the optical axis AX), but they may be disposed at unequal intervals. In addition, the holding parts 14 of the optical element 10 and the holding members 6 that hold the holding parts 14 are provided at three locations in the circumferential directions of the optical path space K (the optical axis AX), but they may be provided at two locations or an arbitrary number, e.g., four or more, of locations.

Furthermore, in each of the embodiments discussed above, the outer circumferential surface 13 of the optical element 10 is inclined on the object plane Os side (the +Z side) of the emergent surface 12. Namely, the outer circumferential surface 13 is provided on the +Z side of the emergent surface 12, but the present invention is not limited thereto; for example, the outer circumferential surface 13 may be substantially flush with the emergent surface 12. In this case, the effective area from which the exposure light EL emerges should be defined as the emergent surface, and the region outside of that area should be defined as the outer circumferential surface 13. In addition, in this case, the lower surfaces 14C of the holding parts 14, which are formed so that they project toward the substrate P side (the −Z side), are disposed at the circumferential edge part of the outer circumferential surface 13 on the −Z side of (at a position lower than) the emergent surface 12.

In addition, in the embodiments discussed above, the outer circumferential surface 13 is formed so that it forms one straight line within a plane that is parallel to the Z axis, which includes the optical axis AX, as shown in FIG. 4 for example, but the present invention is not limited thereto; for example, the outer circumferential surface 13 may be formed so that it forms a curve within a plane that is parallel to the Z axis, which includes the optical axis AX; alternatively, the outer circumferential surface 13 may be formed so that it forms multiple straight lines that are at different angles from one another within a plane that is parallel to the Z axis, which includes the optical axis AX.

In addition, in the embodiments discussed above, the outer circumferential surface 13 is circular within a plane that is perpendicular to the optical axis AX (the Z axis), but the present invention is not limited thereto; for example, the outer circumferential surface 13 may be polygonal (e.g., rectangular) within a plane that is perpendicular to the optical axis AX (Z axis). In addition, the outer circumferential surface 13 may change shape within a plane that is perpendicular to the optical axis AX (the Z axis) depending on its position in the Z axial directions.

In addition, each of the embodiments discussed above uses the optical element 10, which comprises the holding parts 14 that project to the image plane Is side (the substrate P side), and the first gas supply apparatus 40 (the first gas supply port 41), which supplies the gas G1 to the prescribed space 70 on the incident surface II side of the optical element 10, in parallel, but they do not necessarily have to be used in parallel.

For example, the optical element disclosed in PCT International Publication WO2005/122221 (corresponding U.S. patent application Ser. No. 11/597,745) may be used as the optical element that is closest to the image plane Is (the substrate P) and may be used in parallel with the first gas supply apparatus 40 (the first gas supply port 41). Alternatively, the optical element 10 discussed above may be used without providing the first gas supply apparatus 40 (the first gas supply port 41) that supplies the gas G1 to the prescribed space 70 on the incident surface 11 side of the optical element 10.

Furthermore, in each of the embodiments discussed above, the liquid LQ is not limited to decalin; for example, a liquid that has an O—H bond or a C—H bond, such as isopropanol and glycerol, or a liquid (organic solvent) such as hexane, heptane, or decane, may be used as the liquid LQ. The gas G1 (G2) that is supplied to the gas space 71, which surrounds the immersion space LS, is selected in accordance with the liquid LQ that is used, and should be one that does not change the physical properties (the refractive index) of that liquid LQ. In addition, water (pure water) may be used as the liquid LQ. Alternatively, two or more arbitrary types of these prescribed liquids may be mixed together, or an abovementioned prescribed liquid may be added to (mixed with) pure water. Alternatively, the liquid LQ may be a liquid wherein a base, such as H⁺, Cs⁺, K⁺, Cl⁻, SO₄²⁻, PO₄²⁻, or an acid is added to (mixed with) pure water. Furthermore, the liquid LQ may be a liquid wherein fine particles of aluminum oxide or the like are added to (mixed with) pure water. These liquids can transmit ArF excimer laser light. In addition, the liquid LQ preferably has a small light absorption coefficient, low temperature dependency, and is stable with respect to the photosensitive material (a protective film such as a topcoat film; an antireflection film; or the like) that is coated on the projection optical system PL and/or the front surface of the substrate P.

In addition, the liquids disclosed in, for example, PCT International Publication WO2005/114711, PCT International Publication WO2005/117074, and PCT International Publication WO2005/119371 may be used as the liquid LQ.

Furthermore, in each of the embodiments discussed above, the shapes of the incident surface 11 and the emergent surface 12 of the optical element 10 can be set appropriately so that the desired performance of the projection optical system PL is achieved. For example, the incident surface 11 may be spherically shaped or aspherically shaped. In addition, the emergent surface 12 does not have to be a flat surface, and may be a concave surface that is formed so that it is spaced apart from the front surface Ps of the substrate P.

In addition, in each of the embodiments discussed above, the optical element 10 is the optical element of the plurality of optical elements of the projection optical system PL that is disposed at a position at which it is closest to the image plane Is (the substrate P), but the present invention can also use an optical element that is disposed at another position and wherein the incident surface contacts the gas and the emergent surface contacts the liquid.

In addition, in the embodiments discussed above, the optical path space K on the emergent surface 12 side of the optical element 10 at the terminal end of the projection optical system PL is filled with liquid, but the optical path space on the incident surface 11 side of the optical element 10 may be filled with liquid, as disclosed in, for example, PCT International Publication WO2004/019128.

Furthermore, the substrate P in each of the embodiments discussed above is not limited to a semiconductor wafer for fabricating semiconductor devices, but can also be adapted to, for example, a glass substrate for display devices, a ceramic wafer for thin film magnetic heads, or the original plate of a mask or a reticle (synthetic silica glass or a silicon wafer) that is used by an exposure apparatus. The substrate P is not limited to a circle, and may be another shape, e.g., a rectangle.

The exposure apparatus EX can also be adapted to a step-and-scan type scanning exposure apparatus (a scanning stepper) that scans and exposes the pattern of the mask M by synchronously moving the mask M and the substrate P, as well as to a step-and-repeat type projection exposure apparatus (a stepper) that performs full field exposure of the pattern of the mask M with the mask M and the substrate P in a stationary state, and sequentially steps the substrate P.

In addition, the exposure apparatus EX can also be adapted to an exposure apparatus that uses a projection optical system (e.g., a dioptric projection optical system, which does not include a catoptric element, that has a ⅛ reduction magnification) to expose the substrate P with the full field of a reduced image of a first pattern in a state wherein the first pattern and the substrate P are substantially stationary. In this case, the exposure apparatus EX can also be adapted to a stitching type full field exposure apparatus that subsequently further uses that projection optical system to expose the substrate P with the full field of a reduced image of a second pattern, in a state wherein the second pattern and the substrate P are substantially stationary, so that the second pattern partially overlaps the first pattern. In addition, the stitching type exposure apparatus can also be adapted to a step-and-stitch type exposure apparatus that transfers at least two patterns onto the substrate P so that they are partially superposed, and sequentially steps the substrate P.

In addition, the present invention can also be adapted to a multistage type exposure apparatus that is provided with a plurality of substrate stages, as disclosed in Japanese Patent Application Publication No. H10-163099A, Japanese Patent Application Publication No. H10-214783A, Published Japanese Translation No. 2000-505958 of the PCT International Publication, U.S. Pat. No. 6,341,007, U.S. Pat. No. 6,400,441, U.S. Pat. No. 6,549,269, and U.S. Pat. No. 6,590,634.

Furthermore, the present invention can also be adapted to an exposure apparatus that is provided with a substrate stage that holds the substrate and a measurement stage whereon a fiducial member (wherein a fiducial mark is formed) and/or various photoelectric sensors are mounted, as disclosed in Japanese Patent Application Publication No. H11-135400A, Japanese Patent Application Publication No. 2000-164504A, and U.S. Pat. No. 6,897,963. In addition, the present invention can also be adapted to an exposure apparatus that comprises a plurality of substrate stages and measurement stages.

In each of the abovementioned embodiments, positional information about the mask stage 1 and the substrate stage 2 is measured using an interferometer system, but the present invention is not limited thereto and, for example, an encoder system may be used that detects a scale (diffraction grating) that is provided to the upper surface of the substrate stage. In this case, it is preferable to adopt a hybrid system that is provided with both an interferometer system and an encoder system, and to use the measurement results of the interferometer system to calibrate the measurement results of the encoder system. In addition, the position of the substrate stage may be controlled by switching between the interferometer system and the encoder system, or by using both.

The type of exposure apparatus EX is not limited to a semiconductor device fabrication exposure apparatus that exposes the pattern of a semiconductor device on the substrate P, but can also be widely adapted to exposure apparatuses that are used for fabricating, for example, liquid crystal devices or displays, and exposure apparatuses that are used for fabricating thin film magnetic heads, image capturing devices (CCDs), micromachines (MEMS), DNA chips, or reticles and masks.

Furthermore, in the embodiments discussed above, a light transmitting type mask is used wherein a prescribed shielding pattern (or a phase pattern or a dimming pattern) is formed on a light transmitting substrate; however, instead of such a mask, it is also possible to use an electronic mask wherein a transmittance pattern, a reflected pattern, or a light emitting pattern is formed based on electronic data of the pattern to be exposed, as disclosed in, for example, U.S. Pat. No. 6,778,257; here, an electronic mask, which is also called a variable forming mask, includes, for example, a digital micromirror device (DMD), which is one type of a non light emitting image display device (a spatial light modulator).

In addition, by forming interference fringes on the substrate P as disclosed in, for example, PCT International Publication WO2001/035168, the present invention can also be adapted to an exposure apparatus (a lithographic system) that exposes the substrate P with a line-and-space pattern.

Furthermore, the present invention can also be adapted to an exposure apparatus that combines, through a projection optical system, the patterns of two masks on a substrate, and double exposes, substantially simultaneously, a single shot region on that substrate with a single scanning exposure, as disclosed in, for example, Published Japanese Translation No. 2004-519850 of the PCT International Publication (corresponding U.S. Pat. No. 6,611,316).

As far as is permitted, each disclosure of every published document and U.S. patent related to the exposure apparatus recited in each of the embodiments discussed above, modified examples, and the like is hereby incorporated by reference. U.S.

The exposure apparatus EX in the embodiments discussed above is manufactured by assembling various subsystems, including each constituent element, so that prescribed mechanical, electrical, and optical accuracies are maintained. To ensure these various accuracies, adjustments are performed before and after this assembly, including an adjustment to achieve optical accuracy for the various optical systems, an adjustment to achieve mechanical accuracy for the various mechanical systems, and an adjustment to achieve electrical accuracy for the various electrical systems. The process of assembling the exposure apparatus EX from the various subsystems includes, for example, the mechanical interconnection of the various subsystems, the wiring and connection of electrical circuits, and the piping and connection of the atmospheric pressure circuit. Naturally, prior to performing the process of assembling the exposure apparatus EX from these various subsystems, there are also the processes of assembling each individual subsystem. When the process of assembling the exposure apparatus EX from the various subsystems is complete, a comprehensive adjustment is performed to ensure the various accuracies of the exposure apparatus EX as a whole. Furthermore, it is preferable to manufacture the exposure apparatus EX in a clean room wherein, for example, the temperature and the cleanliness level are controlled.

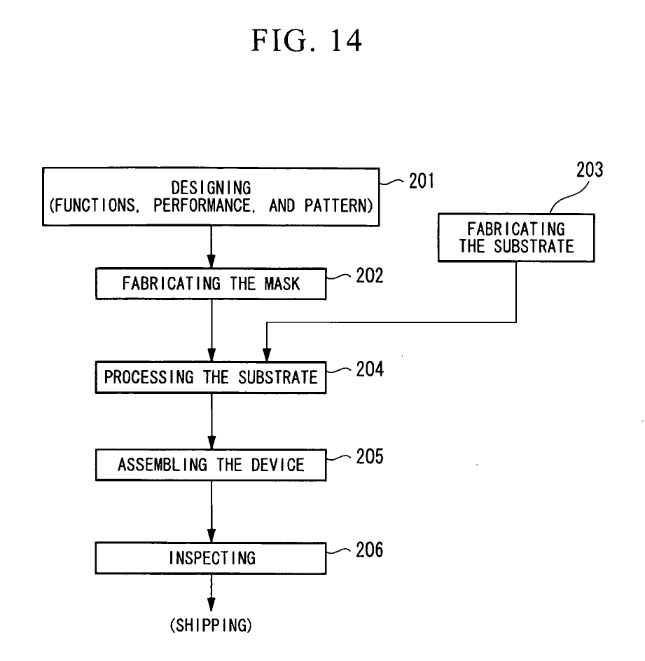

As shown in FIG. 14, a microdevice, such as a semiconductor device, is manufactured by, for example: a step 201 that designs the functions and performance of the micro-device; a step 202 that fabricates a mask (reticle) based on this designing step; a step 203 that fabricates a substrate, which is the base material of the device; a step 204 that includes substrate treatment processes, such as the exposure process that exposes the pattern of the mask onto the substrate by using the exposure apparatus EX of the embodiments discussed above, a process that develops the exposed substrate, and a process that heats (cures) and etches the developed substrate; a device assembling step 205 (comprising a dicing process, a bonding process, and a packaging process); and an inspecting step 206.

What is claimed is:

1. A projection optical system that projects an image of a first surface to a second surface through a liquid, comprising:
an optical element, which comprises:
an incident surface, which is convex toward the first surface;
an emergent surface;
an outer circumferential surface between an outer circumference of the incident surface and an outer circumference of the emergent surface; and
holding parts, which are formed at a circumferential edge part of the outer circumferential surface so that the holding parts project toward the second surface;
wherein,
the incident surface contacts a gas; and
the emergent surface contacts the liquid.

2. A projection optical system according to claim 1, wherein
the holding parts of the optical element are formed at a plurality of locations of the circumferential edge part of the outer circumferential surface so that the holding parts are spaced apart from one another.

3. A projection optical system according to claim 1, wherein
the emergent surface of the optical element is substantially parallel to the second surface; and
the outer circumferential surface of the optical element has an inclined surface that is inclined toward the incident surface with respect to the emergent surface.

4. A projection optical system according to claim 1, wherein
a space is formed between the holding parts and the outer circumferential surface at least along a direction that is perpendicular to the optical axis of the optical element.

5. An exposing method, comprising:
filling a space between a substrate and a projection optical system according to claim 1 with a liquid; and
exposing the substrate through the projection optical system and the liquid.

6. An exposure apparatus comprising:
a projection optical system according to claim 1, a substrate being irradiated and exposed with exposure light through the projection optical system and a liquid.

7. An exposure apparatus that exposes a substrate by radiating exposure light to the substrate through a liquid, comprising:
an optical element, which comprises:
an incident surface into which the exposure light enters;
an emergent surface from which the exposure light emerges;
an outer circumferential surface between an outer circumference of the incident surface and an outer circumference of the emergent surface; and
holding parts, which are formed at a circumferential edge part of the outer circumferential surface so that the holding parts project toward the substrate; and
an immersion space forming member, which forms an immersion space between the optical element and a front surface of the substrate;
wherein,
a space is formed between the holding parts and the outer circumferential surface at least along a direction that is perpendicular to the optical axis of the optical element; and
at least part of the immersion space forming member is disposed in the space.

8. An exposure apparatus according to claim 7, wherein
the emergent surface of the optical element is substantially parallel to the front surface of the substrate; and
the outer circumferential surface of the optical element has an inclined surface that is inclined toward the incident surface with respect to the emergent surface.

9. An exposure apparatus according to claim 7, wherein
the holding parts of the optical element are formed at a plurality of locations of the circumferential edge part of the outer circumferential surface so that they are spaced apart from one another.

10. An exposure apparatus according to claim 8, wherein
at least part of the immersion space forming member is disposed between the holding parts of the optical element.

11. An exposure apparatus according to claim 7, comprising:
a first gas supply port, which supplies a gas to a prescribed space on the incident surface side of the optical element; and
a gas passageway that is in fluid communication with the prescribed space and at least part of the gas space, which surrounds the immersion space, so that the gas that is supplied via the first gas supply port contacts the liquid of the immersion space.

12. An exposure apparatus that exposes a substrate by radiating exposure light to the substrate through a liquid, comprising:
an optical element that has an incident surface into which the exposure light enters, and an emergent surface from which the exposure light emerges;
an immersion space forming member, which forms an immersion space between the optical element and a front surface of the substrate;
a first gas supply port, which supplies a gas to a prescribed space on the incident surface side of the optical element; and
a gas passageway, which is in fluid communication with the prescribed space and at least part of the gas space, which surrounds the immersion space, so that the gas that is supplied via the first gas supply port contacts the liquid of the immersion space.

13. An exposure apparatus according to claim 11, wherein
the gas comprises an inert gas.

14. An exposure apparatus according to claim 11, further comprising:
an exhaust port, which discharges the gas that flows from the prescribed space into the gas space.

15. An exposure apparatus according to claim 14, wherein
the exhaust port is disposed so that the exhaust port surrounds the immersion space.

16. An exposure apparatus according to claim 14, wherein
the exhaust port is disposed so that the exhaust port opposes the front surface of the substrate.

17. An exposure apparatus according to claim 17, further comprising:
a second gas supply port that supplies the gas to at least part of the gas space, which surrounds the immersion space.

18. An exposure apparatus according to claim 17, wherein
the second gas supply port is disposed so that the second gas supply port opposes the front surface of the substrate.

19. An exposure apparatus according to claim 11, further comprising:
a second gas supply port, which supplies the gas to at least part of the gas space, which surrounds the immersion space.

20. An exposure apparatus according to claim 11, comprising:
a holding member that holds the optical element;
wherein,
the holding member holds the optical element so that the gas passageway is formed.

21. An exposure apparatus according to claim 20, wherein
the holding member comprises a lens barrel, which holds a plurality of optical elements that comprises said optical element; and
the prescribed space on the incident surface side of said optical element is formed in the interior of the lens barrel.

22. An exposure apparatus that exposes a substrate by radiating exposure light to the substrate through a liquid, comprising:
an optical element, which comprises:
an incident surface into which the exposure light enters;
an emergent surface from which the exposure light emerges;
an outer circumferential surface between an outer circumference of the incident surface and an outer circumference of the emergent surface; and
holding parts, which are formed at a circumferential edge part of the outer circumferential surface so that the holding part projects toward the substrate; and
an immersion space forming member, which forms an immersion space between the optical element and a front surface of the substrate;
wherein,
a space is formed between the optical axis of the optical element and the holding parts; and
at least part of the immersion space forming member is disposed in the space.

23. A device fabricating method, comprising:
exposing a substrate using an exposure apparatus according to claim 6; and
developing the exposed substrate.
